(19) United States
(12) Patent Application Publication
(10) Pub. No.: US 2026/0241288 A1
(43) Pub. Date: Aug. 20, 2026

(54) METHOD AND APPARATUS FOR SUMMONING VIRTUAL PET CHARACTER, DEVICE, MEDIUM, AND PROGRAM PRODUCT

(71) Applicant: Tencent Technology (Shenzhen) Company Limited, Shenzhen (CN)

(72) Inventor: Xiusheng SONG, Shenzhen (CN)

(21) Appl. No.: 19/652,904

(22) Filed: Apr. 20, 2026

Related U.S. Application Data
(63) Continuation of application No. PCT/CN2025/103722, filed on Jun. 26, 2025.

(30) Foreign Application Priority Data
Aug. 7, 2024 (CN) 202411083416.4

(51) Int. Cl. A63F 13/56; A63F 13/52; A63F 13/537; A63F 13/77

(52) U.S. Cl. CPC A63F 13/56; A63F 13/52; A63F 13/537; A63F 13/77

(57) ABSTRACT

A method for summoning a virtual minion character performed by a computer device is provided. The method includes: displaying a graphical user interface of a virtual scene including a master virtual object; in response to a character summoning operation for summoning a first virtual minion character in the virtual scene; determining, among a plurality of candidate positions, a candidate position whose corresponding summoning matching data meets a first matching requirement as a first position within a current field of view of the master virtual object; and displaying a summoned first virtual minion character at the first position within the current field of view.

### CROSS-REFERENCE TO RELATED APPLICATIONS

This application is a continuation application of PCT Patent Application No. PCT/CN2025/103722, entitled “METHOD AND APPARATUS FOR SUMMONING VIRTUAL PET CHARACTER, DEVICE, MEDIUM, AND PROGRAM PRODUCT” filed on June 26, 2025, which claims priority to Chinese Patent Application No. 202411083416.4, entitled "METHOD AND APPARATUS FOR SUMMONING VIRTUAL PET CHARACTER, DEVICE, MEDIUM, AND PROGRAM PRODUCT" and filed on August 7, 2024, all of which are incorporated herein by reference in their entirety.

### FIELD OF THE TECHNOLOGY

Embodiments of this application relate to the field of human-computer interaction, and to a method and an apparatus for summoning a virtual minion character, a device, a medium, and a program product.

### BACKGROUND OF THE DISCLOSURE

Currently, in a game application, a player may summon a virtual minion character (such as a virtual pet or a virtual mount) to implement an interesting game process.

In the related art, in a process in which a player controls a master virtual object, when the master virtual object is equipped with a summoning item for summoning a virtual minion character, the player may trigger a character summoning control, manually select a summoning position in a virtual scene, and summon the virtual minion character at the summoning position by throwing the summoning item to the summoning position.

The summoning process is complex. Due to complexity of the virtual scene, there may be a deviation between the position at which the virtual minion character appears and the manually selected position, leading to low efficiency of summoning the virtual minion character and low efficiency of human-computer interaction in the game process.

### SUMMARY

Embodiments of this application provide a method and an apparatus for summoning a virtual minion character, a device, a medium, and a program product, which can determine, based on a specified element affecting a character summoning result within a current field of view of a master virtual object, a first position more suitable for summoning a virtual minion character within the current field of view, thereby summoning and displaying a first virtual minion character at the first position, avoiding relying on a manual operation of a player to determine a summoning position of the virtual minion character, and improving display flexibility of the virtual minion character and efficiency of human-computer interaction. Technical solutions are as follows.

According to an aspect, a method for summoning a virtual minion character is performed by a computer device. The method includes:

displaying a graphical user interface of a virtual scene including a master virtual object, the master virtual object having a capability of summoning a virtual minion character captured by the master virtual object in the virtual scene;

receiving a character summoning operation for summoning a first virtual minion character in the virtual scene;

in response to the character summoning operation, determining, within a current field of view of the master virtual object, summoning matching data respectively corresponding to a plurality of candidate positions based on a positional relationship between the candidate positions and an element position of at least one specified element within the current field of view;

determining, among the plurality of candidate positions, a candidate position whose corresponding summoning matching data meets a first matching requirement as a first position within the current field of view; and

displaying the summoned first virtual minion character at the first position within the current field of view.

According to another aspect, a computer device is provided. The computer device includes a processor and a memory. The memory has at least one instruction, at least one program, a code set, or an instruction set stored therein. The at least one instruction, the at least one program, the code set, or the instruction set, when executed by the processor, causes the computer device to implement the method for summoning a virtual minion character according to any one of the foregoing embodiments of this application.

According to another aspect, a non-transitory computer-readable storage medium is provided. The storage medium has at least one instruction, at least one program, a code set, or an instruction set stored therein. The at least one instruction, the at least one program, the code set, or the instruction set, when executed by a processor of a computer device, causes the computer device to implement the method for summoning a virtual minion character according to any one of the foregoing embodiments of this application.

The technical solutions provided in embodiments of this application produce at least the following beneficial effects.

A first position is dynamically determined based on an element position of at least one specified element within a current field of view when a character summoning operation configured for summoning a first virtual minion character is received, thereby displaying that the first virtual minion character is selected as a servant at the first position. At least one specified element within a field of view affecting the character summoning result of the first virtual minion character is used as a factor during summoning of a virtual minion character, so that a more suitable first position for summoning the first virtual minion character is dynamically selected by using the element position of the at least one specified element in the virtual scene. This improves efficiency of selecting the first position, avoids relying on manual operation of a player to determine the summoning position of the virtual minion character, improves the display flexibility of the virtual minion character, lowers an operational threshold for summoning the virtual minion character, and improves efficiency of human-computer interaction.

### BRIEF DESCRIPTION OF THE DRAWINGS

FIG. 1 is a structural block diagram of a summoning system according to an exemplary embodiment of this application.

FIG. 2 is a flowchart of a method for summoning a virtual minion character according to an exemplary embodiment of this application.

FIG. 3 is a flowchart of determining a first position based on summoning matching data and displaying a first virtual minion character according to an exemplary embodiment of this application.

FIG. 4 is a schematic diagram of selecting a plurality of candidate positions according to an exemplary embodiment of this application.

FIG. 5 is a schematic diagram of determining summoning matching data respectively corresponding to a plurality of candidate positions according to an exemplary embodiment of this application.

FIG. 6 is a flowchart of selecting a first virtual minion character according to an exemplary embodiment of this application.

FIG. 7 is a flowchart of displaying a first virtual minion character at a position of a summoning indicator element according to an exemplary embodiment of this application.

FIG. 8 is a schematic diagram of displaying a virtual light beam as a summoning indicator element according to an exemplary embodiment of this application.

FIG. 9 is a schematic diagram of selecting a first position based on a position evaluation score according to an exemplary embodiment of this application.

FIG. 10 is a schematic diagram of an interface of displaying a first virtual minion character according to an exemplary embodiment of this application.

FIG. 11 is a flowchart of displaying a first virtual minion character at a first position in a highlight region according to an exemplary embodiment of this application.

FIG. 12 is a schematic diagram of an interface of displaying a highlight region according to an exemplary embodiment of this application.

FIG. 13 is a schematic diagram of determining summoning matching data in a highlight region according to an exemplary embodiment of this application.

FIG. 14 is a schematic diagram of an interface of displaying a first virtual minion character at a first position in a highlight region according to an exemplary embodiment of this application.

FIG. 15 is a schematic flowchart of summoning according to an exemplary embodiment of this application.

FIG. 16 is a structural block diagram of an apparatus for summoning a virtual minion character according to an exemplary embodiment of this application.

FIG. 17 is a structural block diagram of a terminal according to an exemplary embodiment of this application.

### DESCRIPTION OF EMBODIMENTS

Virtual scene: a virtual scene displayed (or provided) when an application program is run on a terminal.

Virtual model: a model configured to imitate a real scene in a virtual scene.

Virtual character/virtual object: a movable object in a virtual scene.

An embodiment of this application provides a method for summoning a virtual minion character, which can determine, based on a specified element affecting a character summoning result within a current field of view of a master virtual object, a first position more suitable for summoning a virtual minion character within the current field of view, thereby summoning and displaying a first virtual minion character at the first position, avoiding relying on a manual operation of a player to determine a summoning position of the virtual minion character, and improving display flexibility of the virtual minion character and efficiency of human-computer interaction. The method for summoning a virtual minion character provided in this embodiment of this application may be applied to a plurality of virtual scenes such as an online game scene, a virtual reality scene, a virtual guide scene, and a virtual assistant scene, which is not limited in this embodiment of this application.

In this application, before user-related data is collected and during collection of the user-related data, a prompt interface or a pop-up window can be displayed, or voice prompt information can be outputted. The prompt interface, the pop-up window, or the voice prompt information is configured for prompting a user that the user-related data is currently being collected. In this way, in this application, related operations of obtaining the user-related data start to be performed only after a confirmation operation of the user on the prompt interface or the pop-up window is obtained. Otherwise (that is, when no confirmation operation of the user on the prompt interface or the pop-up window is obtained), the related operations of obtaining the user-related data are ended, that is, the user-related data is not to be obtained. In other words, all user data collected in this application is collected with user consent and authorization, and collection, use, and processing of the user-related data need to comply with relevant laws, regulations, and standards of relevant regions.

A summoning system involved in embodiments of this application is described. The method for summoning a virtual minion character provided in this embodiment of this application may be performed by a terminal independently, or may be implemented through data exchange between a terminal and a server, which is not limited in the embodiments of this application. In some embodiments, an example in which the method for summoning a virtual minion character is performed through interaction between a terminal and a server is used for description.

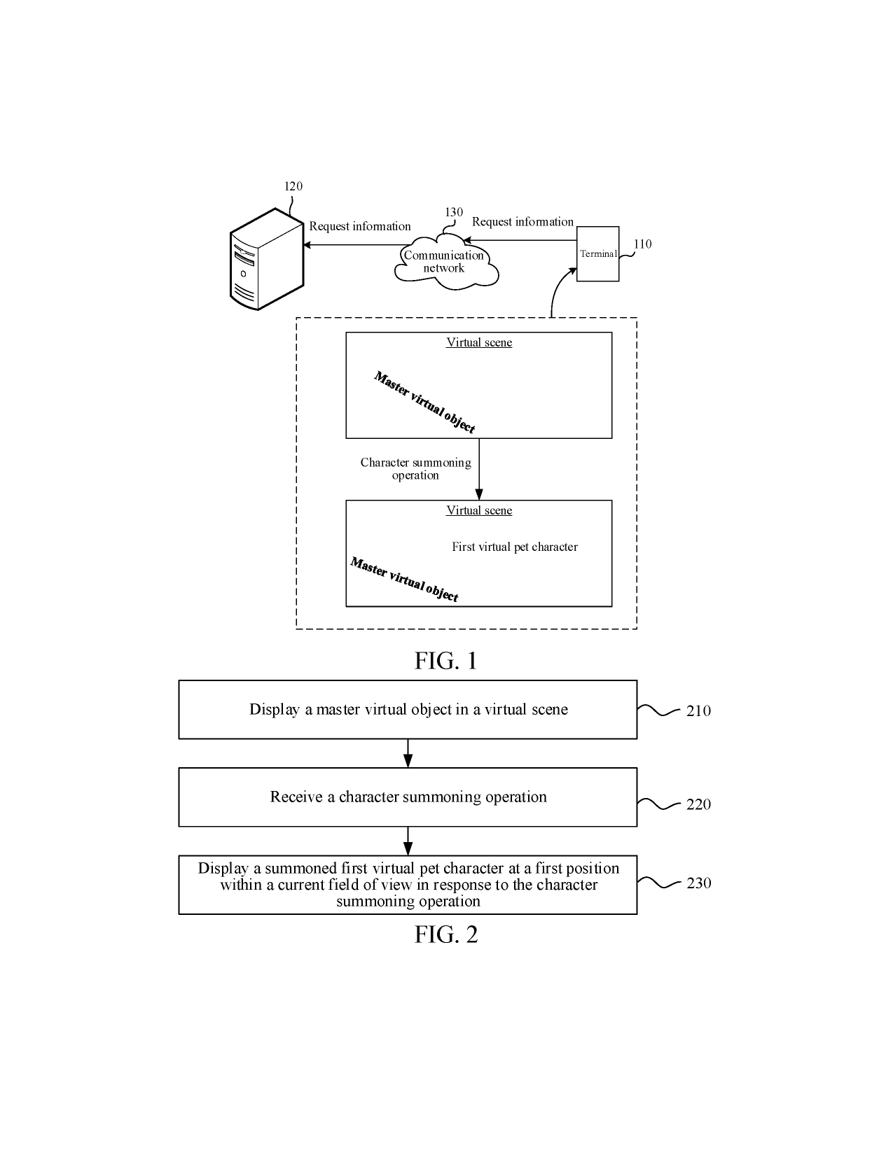

For example, referring to FIG. 1, the summoning system relates to a terminal 110 and a server 120. The terminal 110 and the server 120 are connected through a communication network 130.

In some embodiments, a game application program is installed in the terminal 110, and a master virtual object in a virtual scene is displayed during running of the game application program.

The master virtual object has a capability of summoning a virtual minion character. The virtual minion character includes a pet character captured by the master virtual object in a virtual scene. For example, a virtual minion character 1 is a pet character captured by the master virtual object at a position A in a virtual scene, such as a virtual pupil; and a virtual minion character 2 is a pet character captured by the master virtual object at a position B in a virtual scene, for example, a virtual monster.

In some embodiments, the terminal 110 receives a character summoning operation.

The character summoning operation is configured for summoning a first virtual minion character. The first virtual minion character is a virtual minion character selected as a servant of the master virtual object. For example, a virtual minion character is selected from a plurality of captured virtual minion characters as the first virtual minion character based on selection of a player, and the character summoning operation is received to summon the first virtual minion character.

In some embodiments, the terminal 110 displays the summoned first virtual minion character at a first position within a current field of view in response to the character summoning operation. The first position is dynamically determined based on an element position of at least one specified element within the current field of view. For example, after receiving the character summoning operation, the terminal 110 automatically determines the current field of view. For example, the current field of view is determined by using the master virtual object as a first viewing angle; or the current field of view is determined by using a third viewing angle. The first position is then dynamically determined based on the element position of the at least one specified element within the current field of view.

The specified element is a virtual element affecting a character summoning result of the first virtual minion character within the current field of view. The character summoning result is, for example, a character summoning success result or a character summoning failure result, or a character summoning assistance result (for example, an objective of summoning the first virtual minion character is to assist the master virtual object in mining resources, performing a virtual battle, or the like), or a character summoning defense result (for example, the objective of summoning the first virtual minion character is to defend against an attack of another virtual object on the master virtual object).

For example, the specified element is a virtual resource, a position closest to the virtual resource within the current field of view is used as the first position, and a high-efficient mining process is performed on the virtual resource by displaying the first virtual minion character at the first position.

In some embodiments, after receiving the character summoning operation, the terminal 110 sends request information to the server 120 through the communication network 130, to request the server 120 to deliver a character animation corresponding to the first virtual minion character. The terminal 110 receives the character animation delivered by the server 120 through the communication network 130, and renders and displays a first virtual character animation at the first position, to display the summoned first virtual minion character at the first position on a screen of the terminal 110. Alternatively, after the terminal 110 receives the character summoning operation, the communication network 130 sends request information including position information corresponding to the first position to the server 120, to request the server 120 to deliver a character rendering animation in which the first virtual minion character is rendered and displayed at the first position. The terminal 110 receives, through the communication network 130, the character rendering animation delivered by the server 120, to display the summoned first virtual minion character at the first position on the screen of the terminal 110.

In some embodiments, in response to receiving the character control operation, the terminal 110 may control the first virtual minion character to perform an exploration activity in the virtual scene; or when the first virtual minion character is successfully summoned, the terminal 110 may automatically control the first virtual minion character to perform an exploration activity and the like in the virtual scene. For example, the terminal 110 automatically controls the first virtual minion character to perform the exploration activity in the virtual scene; or the terminal 110 controls, based on an operation (a character control operation) of the player, the first virtual minion character to perform the exploration activity in the virtual scene, or the like.

For example, the terminal 110 automatically controls the first virtual minion character to gather the virtual resource in the virtual scene; or the terminal 110 controls, based on an operation of the player, the first virtual minion character to construct a virtual house or the like in the virtual scene.

The terminal includes, but is not limited to, a mobile terminal such as a mobile phone, a tablet computer, a portable laptop computer, an intelligent voice interaction device, an intelligent appliance, or an in-vehicle terminal, or may be implemented as a desktop computer or the like. The server may be an independent physical server, or may be a server cluster formed by a plurality of physical servers or a distributed system, or may be a cloud server.

With reference to the foregoing term introduction and application scenarios, the method for summoning a virtual minion character provided in this application is described. An example in which the method is applied to a terminal is used for description. FIG. 2 is a flowchart of a method for summoning a virtual minion character according to an exemplary embodiment of this application. As shown in FIG. 2, the method includes the following operation 210 to operation 230.

Operation 210: Display a graphical user interface of a virtual scene including a master virtual object in the virtual scene.

In some embodiments, the virtual scene is a scene displayed when an application program is run on a terminal; or the virtual scene is a scene displayed by projection. The virtual scene may be a simulated scene of a real scene, may be a semi-simulated and semi-fictional scene, or may be a completely fictional scene. The virtual scene may be any one of a two-dimensional virtual scene, a 2.5-dimensional virtual scene, or a three-dimensional virtual scene. For example, the master virtual object is a virtual character manually controlled by a player, for example, a virtual hero in a virtual scene. The master virtual object has a capability of summoning a virtual minion character.

For example, the master virtual object participates in a virtual battle or performs a virtual task of one or more persons in the virtual scene. In the virtual scene, the master virtual object controlled by the player exists, and a virtual minion character that can interact with the master virtual object further exists. A design of the virtual minion character may allow the player to experience companionship in the virtual scene by simulating a real animal or in a role play manner, thereby helping, by using the virtual minion character, the master virtual object to participate in the virtual battle and/or complete the virtual task. The summoning capability is a capability configured to summon a virtual minion character, and through a process of summoning the virtual minion character, a master virtual object can be assisted better by the virtual minion character.

In some embodiments, the summoning capability is a capability configured for a master virtual object in advance (for example, a master virtual object having a virtual minion character has a summoning capability by default); or the summoning capability is a capability obtained when a master virtual object reaches a preset condition (for example, the summoning capability is unlocked when an object level of the master virtual object reaches a preset level, or the master virtual object steps into a preset region to obtain the summoning capability); or the summoning capability is a capability obtained when the master virtual object has a summoning item, and the like. A manner of obtaining the summoning capability is not limited herein.

In some embodiments, an implementation of the summoning capability includes at least one of the following: (1) summoning a virtual minion character captured in advance into a virtual backpack to a virtual scene; or (2) summoning a virtual minion character moving at a specific position in a virtual scene to another position. An implementation of the summoning capability is not limited herein.

The virtual minion character includes a pet character captured in the virtual scene by the master virtual object.

In some embodiments, the virtual minion character is a virtual character captured in the virtual scene by the master virtual object. For example, virtual minion characters are scattered at a plurality of positions in the virtual scene, and the master virtual object captures the virtual minion characters through virtual interaction with the virtual minion characters. For example, the player controls the master virtual object and the virtual minion character to perform a virtual battle, search, place a bait, set a virtual trap, or fish, to capture the virtual minion character in the virtual scene. For example, the player controls the master virtual object to set a virtual trap in a region 1 in the virtual scene, and when the virtual minion character steps into the region 1, the virtual minion character is captured.

Operation 220: Receive a character summoning operation for summoning a first virtual minion character in the virtual scene.

For example, in a game process, the terminal may receive the character summoning operation initiated by the player. For example, a click/tap operation performed by the player on a character summoning control is used as the character summoning operation; or a long-press operation performed by the player on the character summoning control is used as the character summoning operation (for example, starting the long-press operation is considered as that the character summoning operation is started, and ending the long-press operation is considered as that the character summoning operation is completed); or a trigger operation of performing a specified gesture on an interface by the player is used as the character summoning operation (for example, an operation of drawing a circle on an interface by the player is used as the character summoning operation); or a selection operation that the player opens a virtual backpack and selects a virtual minion character is used as the character summoning operation. A manner of the character summoning operation is not limited herein.

The character summoning operation is configured for summoning a first virtual minion character. The first virtual minion character is a virtual minion character selected as a servant of the master virtual object. For example, the character summoning operation points to the first virtual minion character, and the first virtual minion character may be summoned by performing the character summoning operation, so that the first virtual minion character can perform a virtual activity in the virtual scene.

In some embodiments, the master virtual object captures a plurality of virtual minion characters, selects the first virtual minion character in advance from the plurality of virtual minion characters, and when the character summoning operation such as a click/tap operation or a long-press operation is received, summons the previously selected first virtual minion character by default.

In some embodiments, the master virtual object captures a plurality of virtual minion characters, and uses a selection operation for the first virtual minion character as the character summoning operation, to summon the first virtual minion character.

In some embodiments, the master virtual object captures a plurality of virtual minion characters. The plurality of virtual minion characters are displayed based on a long-press operation when the long-press operation performed on the character summoning control is used as the character summoning operation, the long-press operation ends when a pointer of the character summoning control points to the first virtual minion character in the plurality of virtual minion characters, and the long-press operation is used as the character summoning operation, to summon the first virtual minion character.

In some embodiments, the master virtual object captures a plurality of virtual minion characters. The plurality of virtual minion characters are displayed based on a dragging operation when the dragging operation performed on the character summoning control is used as the character summoning operation, and a dragging operation performed on the first virtual minion character dragged to the plurality of virtual minion characters is used as the character summoning operation, to summon the first virtual minion character.

The foregoing pointing relationship between the character summoning operation and the first virtual minion character is merely an exemplary example. The first virtual minion character may be a single virtual minion character, or may be a plurality of virtual minion characters, which is not limited in this embodiment of this application.

For example, based on the character summoning operation pointing to the first virtual minion character, the first virtual minion character is used as a servant of the master virtual object, to assist the master virtual object in more efficiently performing a virtual activity in the virtual scene.

In some embodiments, as the servant of the master virtual object, the first virtual minion character follows the master virtual object to perform the virtual activity in the virtual scene; and/or the first virtual minion character executes, in the virtual scene, a virtual instruction (for example, cultivating virtual land or gathering virtual resources) issued by the master virtual object; and/or the first virtual minion character protects the master virtual object (for example, defends against an attack of an enemy virtual object and/or attacks an enemy virtual object) in the virtual scene. The virtual activity performed by the selected first virtual minion character is not limited herein.

Operation 230: Display a summoned first virtual minion character at a first position within a current field of view in response to the character summoning operation.

For example, under the character summoning operation, the current field of view is determined, and the first position is determined from the current field of view, so that the summoned first virtual minion character is displayed at the first position.

In some embodiments, the current field of view is a field of view corresponding to the master virtual object. For example, when the virtual scene is displayed from a first-person viewing angle, the current field of view is a range determined based on both a position and an orientation of the master virtual object; or when the virtual scene is displayed from a third-person viewing angle, the current field of view is also a range determined based on both a position and an orientation of the master virtual object, but a position, an observation angle, and the like of a virtual camera observing the master virtual object may also be considered. However, generally, the current field of view is a range determined based on the position and the orientation of the master virtual object. In addition, based on the current field of view, the first position configured for displaying the summoned first virtual minion character further needs to be determined. The first position is dynamically determined based on an element position of at least one specified element within the current field of view.

The specified element is a virtual element affecting a character summoning result of the first virtual minion character within the current field of view.

For example, many virtual elements are displayed in advance in the virtual scene. The virtual element is at least one of a plurality of elements such as a virtual object (a non-player character or an object controlled by another player), a virtual minion character, a virtual obstacle (such as a virtual building or a virtual wall), a virtual terrain, or a virtual resource.

In some embodiments, the specified element is a virtual element existing in a virtual scene, and the specified element includes at least one of the following virtual elements.

### 1. Virtual resource

For example, the specified element is the virtual resource in the virtual scene, and the virtual resource is a resource that can be mined in the virtual scene, such as a virtual deposit, a virtual water resource, or a virtual forest. In some embodiments, a position closest to the virtual resource is determined as the first position within the current field of view based on a position of the virtual resource in the virtual scene. For example, a position closest to a virtual deposit is used as the first position.

### 2. Virtual object (master virtual object or another virtual object)

For example, the another virtual object includes at least one of an enemy virtual object or a teammate virtual object. The teammate virtual object is a virtual object in the same virtual camp as the master virtual object, and the enemy virtual object is a virtual object in a different virtual camp from the master virtual object. In some embodiments, an example in which the specified element is the enemy virtual object in the virtual scene is used. A specific position at 5 m from the enemy virtual object is determined as the first position within the current field of view based on a position of the enemy virtual object in the virtual scene, or the like.

### 3. Another virtual minion character

For example, the another virtual minion character includes at least one of another virtual minion character (a virtual minion character other than the first virtual minion character) captured by the master virtual object and a virtual minion character captured by another virtual object. In some embodiments, an example in which the specified element is another virtual minion character 1 captured by the master virtual object is used. Based on a position of the another virtual minion character 1 in the virtual scene, a position closest to the another virtual minion character 1 is determined within the current field of view as the first position, or the like.

### 4. Virtual place

For example, the virtual place is a space region having specific meaning in the virtual scene, such as a virtual hospital, a virtual park, or a virtual office building. In some embodiments, an example in which the specified element is the virtual office building is used. An entrance position of the virtual office building is determined within the current field of view as the first position based on a position of the virtual office building in the virtual scene, or the like.

### 5. Virtual obstacle

For example, the virtual obstacle is a virtual element, such as a virtual wall or a virtual fence, having an obstructing or hindering function in the virtual scene. In some embodiments, an example in which the specified element is the virtual wall is used. Any position other than the virtual wall is used as the first position within the current field of view based on a position of the virtual wall in the virtual scene, or the like.

### 6. Virtual terrain

For example, the virtual terrain is configured for describing flatness of a virtual ground in the virtual scene, for example, a steep terrain or a gentle terrain. In some embodiments, an example in which the specified element is the virtual terrain. Based on position distribution of the virtual terrain in the virtual scene, a position of any point on the virtual ground corresponding to the gentle terrain is used as the first position within the current field of view, or the like.

The foregoing specified elements are merely exemplary examples, and may be used alone or in combination. For example, the at least one specified element is a virtual obstacle and a virtual resource in the virtual scene. A position of the virtual obstacle is excluded from the current field of view based on respective positions of the virtual obstacle and the virtual resource in the virtual scene, and a position closest to the virtual resource is used as the first position. This is not limited herein.

The element position is position information of a position of the virtual element in the virtual scene, the element position may be usually represented by using element position coordinates, and the element position coordinates are usually determined based on a scene coordinate system (such as a global coordinate system or a local coordinate system) corresponding to the virtual scene. Usually, each virtual element in the virtual scene has respective element position coordinates (that is, an element position). In a process of summoning the first virtual minion character based on the character summoning operation, the current field of view corresponding to the master virtual object is first determined, and then the virtual element affecting the character summoning result of the first virtual minion character is determined within the current field of view as the specified element.

In some embodiments, in terms of whether character summoning succeeds, the character summoning result includes a character summoning success result (that is, the virtual minion character can be successfully summoned) and a character summoning failure result (that is, the virtual minion character cannot be successfully summoned).

In some embodiments, in terms of a function of character summoning, the character summoning result further includes a character summoning assistance result (that is, an objective of summoning the virtual minion character is to assist the master virtual object, for example, assist the master virtual object in participating in a virtual battle, or assist the master virtual object in mining a virtual resource) and a character summoning defense result (that is, an objective of summoning the virtual minion character is to defend against a virtual attack from another virtual object on a master virtual object). The foregoing character summoning result is merely an exemplary example, and any result that may affect summoning of the virtual minion character may be referred to as a character summoning result, which is not limited herein.

In an exemplary embodiment, the first virtual minion character is controlled to perform an exploration activity in the virtual scene.

For example, when the first virtual minion character is displayed at the first position, it is considered that the first virtual minion character is successfully summoned at the first position. Therefore, the first virtual minion character may be automatically controlled to perform the exploration activity in the virtual scene; or the first virtual minion character is controlled, based on the character control operation of the player, to perform the exploration activity in the virtual scene, or the like.

The exploration activity is a virtual activity performed by the first virtual minion character in the virtual scene. The exploration activity includes at least one of a plurality of virtual activities such as a resource mining activity, a house building activity, a farm management activity, a virtual combat activity, an exploration and treasure finding activity, and a social interaction activity, which is not limited in this embodiment of this application.

In conclusion, at least one specified element within a field of view affecting the character summoning result of the first virtual minion character is used as a factor during summoning of a virtual minion character, so that a more suitable first position for summoning the first virtual minion character is dynamically selected by using the element position of the at least one specified element in the virtual scene. This improves efficiency of selecting the first position, avoids relying on manual operation of the player to determine the summoning position of the virtual minion character, improves the display flexibility of the virtual minion character, lowers an operational threshold for summoning the virtual minion character, and improves the efficiency of human-computer interaction.

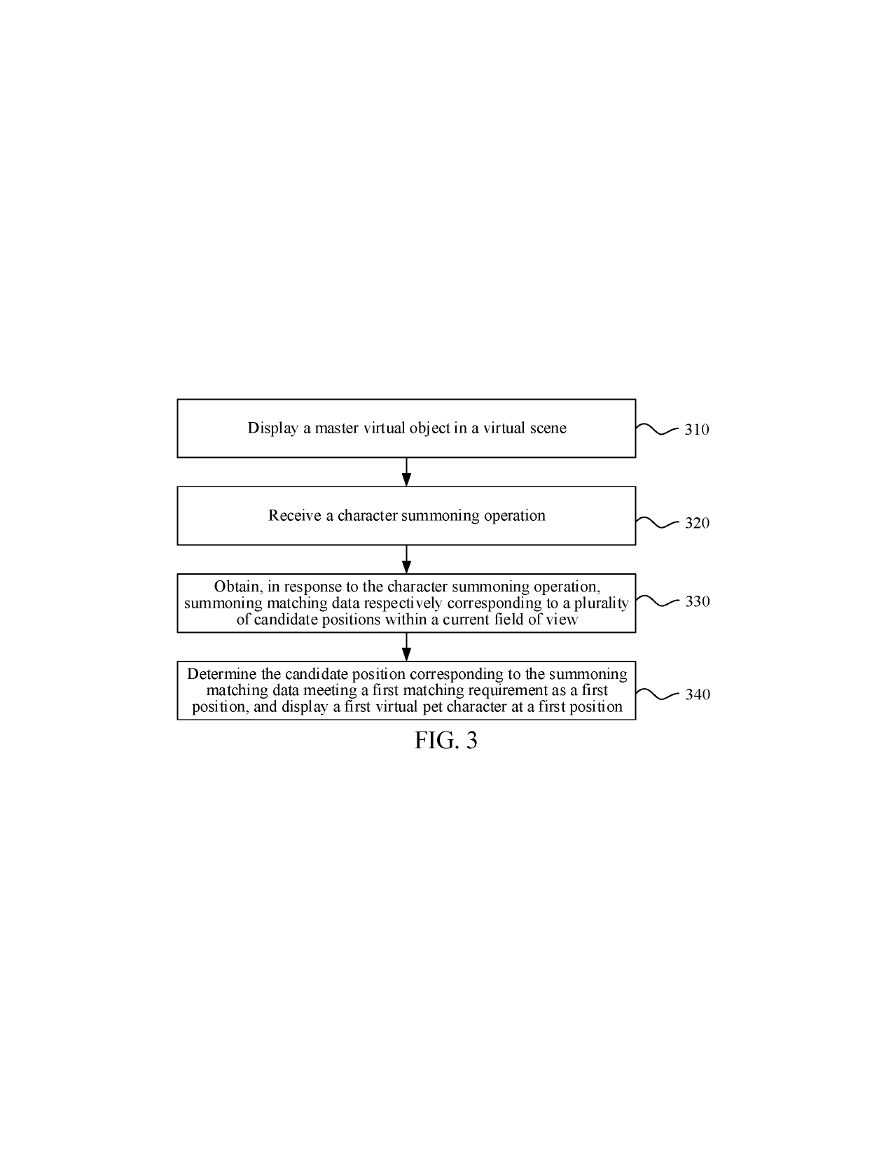

In an exemplary embodiment, a plurality of candidate positions are selected within the current field of view, and when the first position for displaying the summoned first virtual minion character is determined based on the character summoning operation, the first position is selected from the plurality of candidate positions based on summoning matching data respectively corresponding to the plurality of candidate positions. FIG. 3 is a flowchart of determining a first position based on summoning matching data and displaying a first virtual minion character according to an exemplary embodiment of this application. For example, as shown in FIG. 3, the embodiment shown in FIG. 2 may further be implemented as operation 310 to operation 340 below. Operation 230 in the embodiment shown in FIG. 2 may further be implemented as operation 330 and operation 340 below.

Operation 310: Display a graphical user interface of a virtual scene including a master virtual object in the virtual scene.

The master virtual object has a capability of summoning a virtual minion character. The virtual minion character includes a pet character captured by the master virtual object in a virtual scene.

The summoning capability is a capability configured to summon a virtual minion character, and through a process of summoning the virtual minion character, a master virtual object can be assisted better by the virtual minion character.

In some embodiments, the virtual minion character is a virtual character captured in the virtual scene by the master virtual object. For example, virtual minion characters are scattered at a plurality of positions in the virtual scene, and the master virtual object captures the virtual minion characters through virtual interaction (such as virtual attacking, searching, and setting a virtual trap) with the virtual minion characters.

In some embodiments, the virtual minion character is a virtual character raised in the virtual scene by the master virtual object. For example, the master virtual object purchases or exchanges for the virtual minion character in a virtual store by using a virtual redemption resource, and raises the virtual minion character by feeding virtual food to the virtual minion character, supplementing virtual energy to the virtual minion character, and the like.

In some embodiments, the virtual minion character is a virtual character captured in the virtual scene by a teammate virtual object in the same virtual camp as the master virtual object. For example, the master virtual object and at least one teammate virtual object form a virtual camp, and virtual minion characters scattered at a plurality of positions in the virtual scene may be captured in a game process. In the same virtual camp, different teammate virtual objects may share at least one captured virtual minion character. For example, the master virtual object borrows a virtual minion character A captured by a teammate virtual object.

In some embodiments, the virtual minion character is a virtual character obtained by the master virtual object through competition with an enemy virtual object in a different virtual camp. For example, at least one enemy virtual object in a different virtual camp from the master virtual object exists in the virtual scene. After the enemy virtual object captures a virtual minion character B, the master virtual object may compete for ownership of the virtual minion character B from the enemy virtual object through a virtual battle (for example, a virtual attack) with the enemy virtual object, and obtain the virtual minion character B after winning.

The foregoing manners of obtaining the virtual minion character are merely exemplary examples, which are not limited in this embodiment of this application.

Operation 320: Receive a character summoning operation for summoning a first virtual minion character in the virtual scene.

For example, a character summoning control configured to exert a summoning capability exists on a game interface, and a click/tap operation performed by the player on the character summoning control is used as the character summoning operation; or a long-press operation performed by the player on the character summoning control is used as the character summoning operation, or the like. The character summoning operation is configured for summoning a first virtual minion character. The first virtual minion character is a virtual minion character selected as a servant of the master virtual object.

For example, the character summoning operation points to the first virtual minion character, and the first virtual minion character may be summoned by performing the character summoning operation, so that the first virtual minion character assists the master virtual object in an activity.

In some embodiments, the master virtual object captures a plurality of virtual minion characters, selects the first virtual minion character in advance from the plurality of virtual minion characters, and when the character summoning operation for the character summoning control is received, summons the previously selected first virtual minion character by default. In some embodiments, the master virtual object captures a plurality of virtual minion characters. The plurality of virtual minion characters are displayed based on a long-press operation when the long-press operation performed on the character summoning control is used as the character summoning operation, the long-press operation ends when a pointer of the character summoning control points to the first virtual minion character in the plurality of virtual minion characters, and the long-press operation is used as the character summoning operation, to summon the first virtual minion character.

Operation 330: In response to the character summoning operation, determine, within a current field of view of the master virtual object, summoning matching data respectively corresponding to a plurality of candidate positions based on a positional relationship between the candidate positions and an element position of at least one specified element within the current field of view.

For example, in a case of the character summoning operation, a position at which the first virtual minion character is summoned needs to be determined, that is, the first position configured for displaying the first virtual minion character is determined.

In some embodiments, the current field of view corresponding to the master virtual object is determined under the character summoning operation, and the first position configured for displaying the first virtual minion character is selected from the plurality of candidate positions within the current field of view.

For example, a plurality of positions are randomly selected from the current field of view as the plurality of candidate positions; or a plurality of positions are selected as the plurality of candidate positions from the current field of view according to a position selection rule, or the like.

In an exemplary embodiment, the plurality of candidate positions are selected from the current field of view based on a position selection rule in response to the character summoning operation.

The position selection rule is configured for representing density of the selected plurality of candidate positions.

For example, the density is configured for describing a distance relationship between the plurality of candidate positions. When the position selection rule represents that the plurality of candidate positions are sparse, a quantity of candidate positions selected from the current field of view based on the position selection rule is small. When the position selection rule represents that the plurality of candidate positions are dense, a quantity of candidate positions selected from the current field of view based on the position selection rule is large. The position selection rule includes at least one of a first selection rule configured by default or a second selection rule determined based on a rule configuration operation.

For example, the first selection rule configured by default is a rule preconfigured when a system selects the candidate positions. For example, the first selection rule represents that 50 candidate positions are selected from the current field of view; or the first selection rule represents that a preset network is disposed within the current field of view to determine the plurality of candidate positions, or the like.

For example, the second selection rule is a rule user-defined based on a rule configuration operation of the player. For example, the second selection rule determined based on the rule configuration operation represents selecting 10 candidate positions within the current field of view; or the second selection rule represents that a sparse network is used to determine a small number of candidate positions within the current field of view.

The foregoing describes the content of determining the plurality of candidate positions by using the position selection rule under the character summoning operation. A design of the position selection rule can select some position points within the current field of view, which helps to improve character summoning accuracy under the character summoning operation. If the candidate positions are displayed on an interface, it also helps the player to understand more clearly to expand a game strategy layout. Even if the candidate positions selected according to the position selection rule are not displayed on the interface, the design of the position selection rule improves efficiency of selecting the candidate positions, provides a flexible and comprehensive processing manner, and facilitates improving efficiency of human-computer interaction of selecting a position for summoning based on the character summoning operation.

In addition, the position selection rule may be a default first selection rule, to ensure selection efficiency of the candidate positions and avoid a problem that the first position cannot be determined due to the candidate positions failing to be selected. This is applicable to a wide application scenario in which the player has no specific requirement. The position selection rule may alternatively be a user-defined rule based on a rule configuration operation of the player, thereby providing a more personalized implementation for the player, improving flexibility in selecting the candidate positions, satisfying a more complex application scenario, and ensuring the efficiency of human-computer interaction.

In some embodiments, in response to receiving the rule configuration operation, displaying a plurality of configuration options.

The configuration option is configured for adjusting position sparsity when the candidate positions are selected based on the character summoning operation; and the position sparsity is directly proportional to a quantity of the candidate positions. For example, there are three configuration options: sparse, medium, and dense; or the configuration option is a configuration box, and sparsity is adjusted by dragging a configuration control on the configuration box. A display situation of the configuration option is not limited herein.

In some embodiments, in response to receiving a selection operation for a first configuration option in the plurality of configuration options, a first degree of sparsity corresponding to a first configuration option is used as the second selection rule.

For example, each configuration option corresponds to one degree of sparsity, and the degree of sparsity represents a magnitude of sparsity. More sparsity indicates a large magnitude of sparsity and a smaller quantity of selected candidate positions. Less sparsity indicates a smaller magnitude of sparsity and a larger quantity of selected candidate positions.

For example, an example in which the configuration options are the foregoing three options, if the configuration option "sparse" is selected, it represents that the first degree of sparsity is "sparse", and therefore, there is a small quantity of candidate positions. If the configuration option "dense" is selected, it represents that the first degree of sparsity is "dense", and therefore, there are a large quantity of candidate positions. Alternatively, an example in which the configuration option is the foregoing configuration box is used. If the configuration control is dragged to a leftmost side (for example, corresponding to sparsest) of the configuration box, it represents that the first degree of sparsity is "sparsest", and therefore, the quantity of candidate positions is the smallest. If the configuration control is dragged to a rightmost side (for example, corresponding to densest) of the configuration box, it represents that the first degree of sparsity is "densest", and therefore, the quantity of candidate positions is the largest. For example, based on the selection operation for the configuration option, the first degree of sparsity corresponding to the selected first configuration option is determined as the user-defined second selection rule.

In some embodiments, when the first selection rule and the second selection rule are used in combination, subregions to which the first selection rule and the second selection rule are respectively applicable may be preset. For example, the first selection rule is applicable to a subregion 1 within the current field of view; and the second selection rule is applicable to the subregion 2 within the current field of view, and the subregion 1 and the subregion 2 are independent of each other, thereby providing more diversified selection manners for the candidate positions. This is not limited herein.

The foregoing describes the content of determining the second selection rule used as the position selection rule by using the rule configuration operation. A plurality of configuration options are displayed in a process in which the player performs the rule configuration operation, so that the player may selectively adjust sparsity of grids to affect sparsity of the candidate positions, to improve a personalization degree and avoid a problem that a default configuration of the candidate positions does not meet expectation of the player. Operation flexibility of the player based on a game requirement is improved, operation experience of the player is ensured, and the efficiency of human-computer interaction is improved.

In some embodiments, a sectoral region is determined as the current field of view based on an orientation and a position of the master virtual object in response to the character summoning operation.

For example, the current field of view is usually associated with the master virtual object. When the current field of view is determined based on the character summoning operation, the orientation and the position of the master virtual object in the virtual scene are first determined. The orientation is a facing direction of the master virtual object, and the position is position information of the master virtual object in the virtual scene, and can be implemented in a form of position coordinates.

In some embodiments, starting from the position of the master virtual object and using the orientation of the master virtual object as a center line of a sector, a sectoral region enclosed by a preset radius is obtained as the current field of view.

For example, an element position of the master virtual object is a start point of the sector, the preset radius is a radius set in advance, such as 5 m or 10 m, and the orientation of the master virtual object is a sector center, that is, a center for dividing a sectoral angle. In this way, the sectoral region can be obtained as the current field of view. The current field of view is a two-dimensional plane range in a virtual environment, and the two-dimensional plane range is a plane range located on the virtual ground.

In some embodiments, starting from the position of the master virtual object and using the orientation of the master virtual object as a center line of a cone, a cone region enclosed by a preset radius may alternatively be obtained as the current field of view. In this case, the current field of view is a three-dimensional plane range in the virtual environment. A dimension of the current field of view is not limited herein.

In some embodiments, the sectoral region is divided based on a grid size determined according to the position selection rule, to obtain a plurality of grid regions as the plurality of candidate positions.

For example, an example in which the position selection rule is a preset grid size is used. A larger grid size indicates sparser region division, and a smaller grid size indicates denser region division. The position selection rule may be the foregoing default first selection rule, or may be the foregoing user-defined second selection rule, which is not limited herein.

In some embodiments, the sectoral region used as the current field of view is divided based on the grid size, a plurality of grid regions within the current field of view are obtained, and the plurality of candidate positions within the current field of view may be determined by using the plurality of grid regions.

For example, a grid center of the grid region is used as the candidate position; or a preset region boundary point in the grid region is used as the candidate position (for example, a point at an upper left corner of the grid region is used as the candidate position), or the like. A larger grid size indicates a larger area of a grid region and a smaller quantity of candidate positions. A smaller grid size indicates a smaller area of a grid region and a larger quantity of candidate positions.

The foregoing describes the content of selecting the candidate positions when the position selection rule is implemented as a grid size division manner. The sectoral region determined by comprehensively using the orientation and the position of the master virtual object is used as the current field of view based on the character summoning operation, and the sectoral region is divided based on the grid size specified by the position selection rule, so that the plurality of grid regions obtained through division in the sectoral region are respectively used as the candidate positions. If the sectoral region and a division process based on the grid size are presented on the interface, the player can clearly see the candidate positions that are evenly distributed and clearly marked in a current field of view range, richness of interface display is enhanced, and smooth and precise operation experience of the player is also facilitated. In addition, even if the division process based on the grid size is not displayed on the interface, the candidate positions are ensured to be evenly distributed by using the grid region, to avoid a phenomenon that the candidate positions are excessively concentrated or excessively dispersed. Rationality and high efficiency of the candidate positions are improved, and precision and appropriateness of selecting the first position are further ensured.

In some embodiments, when a first grid region including a virtual element exists in the plurality of divided grid regions, the first grid region is discarded; and a plurality of candidate positions are obtained through a second grid region other than the first grid region.

For example, a grid region including a virtual element may exist in the plurality of grid regions, that is, the grid region is located on the virtual element in the virtual scene. For example, the grid region is located on a virtual object (a teammate virtual object or an enemy virtual object), or the grid region is located on a virtual obstacle, or the grid region is located on another virtual minion character. In this case, the grid region is not suitable for summoning the first virtual minion character, that is, the grid region is not a suitable region to select a candidate position. Therefore, the first grid region including the virtual element is discarded.

A grid region obtained from the plurality of grid regions in which the first grid region is discarded is referred to as the second grid region, and the second grid region includes a plurality of grid regions. The plurality of candidate positions are obtained from the plurality of grid regions in the second grid region.

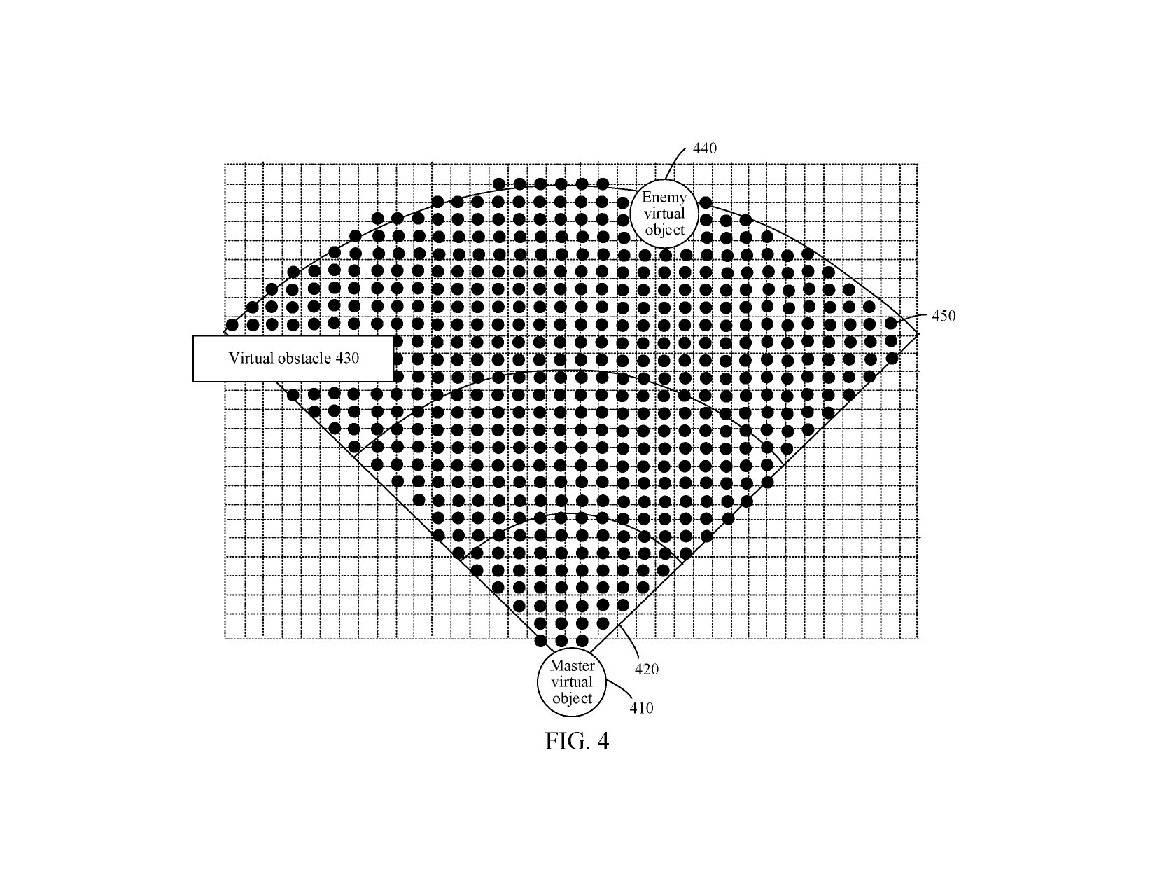

FIG. 4 is a schematic diagram of selecting a plurality of candidate positions. A sectoral region 420 is obtained as the current field of view starting from a position of the master virtual object 410, using an orientation of the master virtual object 410 as a center line of a sector, and using a preset radius as a sectoral radius. The current field of view includes a part of a virtual obstacle 430 and an enemy virtual object 440. The sectoral region 420 is divided by using a grid size determined according to the position selection rule, to obtain a plurality of grid regions shown in FIG. 4. A grid region in the plurality of grid regions that does not include a virtual element (the virtual obstacle 430 and the enemy virtual object 440) is considered as a candidate position, or a grid center in the grid region in the plurality of grid regions that does not include a virtual element is considered as a candidate position, to obtain a plurality of candidate positions 450 shown in FIG. 4.

A grid region located on a boundary of the sectoral region 420 is used as the grid region for selecting the candidate position. There may be a grid region located in the sectoral region 420 but a boundary point of a selected candidate position is located outside the sectoral region 420. The selection herein is merely an exemplary example, and is not limited in this embodiment of this application.

The summoning matching data is data determined based on a positional relationship between the candidate positions and the at least one specified element.

For example, after the plurality of candidate positions are selected, each candidate position is analyzed separately, and a positional relationship between each candidate position and the at least one specified element is determined, to determine the summoning matching data respectively corresponding to the plurality of candidate positions.

In some embodiments, a smaller distance between the candidate position and a specified element indicates a larger value of summoning matching data; and a smaller distance between the candidate position and another specified element indicates a smaller value of summoning matching data. For example, a smaller distance between the candidate position and an enemy virtual object indicates a larger value of summoning matching data; and a smaller distance between the candidate position and a virtual obstacle indicates a smaller value of summoning matching data.

For each candidate position, a positional relationship between the candidate position and the at least one specified element is analyzed, and the summoning matching data is comprehensively determined. For example, for a candidate position 1, a positional relationship between the candidate position 1 and an enemy virtual object is analyzed to obtain data A, a positional relationship between a candidate position 2 and a virtual obstacle is analyzed to obtain data B, and a sum of the data A and the data B is used as matching summoning data corresponding to the candidate position 1, or the like.

In an exemplary embodiment, based on a positional relative relationship between the candidate positions and the at least one specified element in response to the character summoning operation, a gain effect of summoning the first virtual minion character at the candidate positions is evaluated, to obtain position evaluation scores respectively corresponding to the plurality of candidate positions as the summoning matching data.

For example, during analysis of the summoning matching data respectively corresponding to the plurality of candidate positions, each candidate position is analyzed separately, and the gain effect of summoning the first virtual minion character at the candidate position is evaluated based on the positional relative relationship between the candidate position and the at least one specified element within the current field of view. The gain effect is an effect of assisting the master virtual object by using the first virtual minion character. For example, for the candidate position 1, if it is evaluated that a virtual obstacle on a periphery is not beneficial to summoning the first virtual minion character at the candidate position 1, strength of a gain effect is low; and if it is evaluated that an enemy virtual object exists on the periphery when the first virtual minion character is summoned at the candidate position 1, and the enemy virtual object may be attacked after the first virtual minion character is summoned, strength of a gain effect is high, and the like.

In some embodiments, for any candidate position, during evaluation of the gain effect of summoning the first virtual minion character at the candidate position, the positional relative relationship between the candidate position and the at least one specified element is analyzed, to obtain a position evaluation score as the summoning matching data with reference to the gain effect of the at least one specified element on summoning the first virtual minion character at the candidate position.

Strength of the gain effect is directly proportional to a value of the position evaluation score. For example, higher strength of the gain effect indicates a higher position evaluation score; and lower strength of the gain effect indicates a lower position evaluation score.

The foregoing describes the content of evaluating the gain effect by using the positional relative relationship between the candidate positions and the at least one specified element, to obtain the position evaluation score as the summoning matching data. The specified element is used as a virtual element affecting the character summoning result. The positional relative relationship between each candidate position and the at least one specified element is analyzed, to determine whether a virtual minion character summoned at each candidate position is interfered with by the at least one specified element. The gain effect is quantified by using the position evaluation score, so that the gain effect is determined more precisely and intuitively, helping a player to efficiently and select an optimal summoning position as the first position, increasing a decision depth, ensuring that a position evaluation score with a better gain effect is higher, and improving overall operation experience and the efficiency of human-computer interaction.

In some embodiments, for any first candidate position in the plurality of candidate positions, obtaining the position evaluation score includes at least one of the following.

(1) A first distance score is obtained based on a first distance between the first candidate position and the master virtual object.

The first distance is inversely proportional to the first distance score, and the at least one specified element includes the master virtual object.

For example, when the at least one specified element includes the master virtual object, if the position evaluation score is analyzed, a positional relative relationship between the first candidate position and the master virtual object needs to be analyzed, for example, the first distance between the first candidate position and the master virtual object is determined. Using an example in which a smaller first distance indicates a stronger gain effect (inverse proportional relationship), a shorter first distance between the first candidate position and the master virtual object indicates a higher first distance score, and the first candidate position is more helpful to summon the first virtual minion character.

(2) A second distance score is obtained based on a second distance between the first candidate position and another virtual object.

The second distance is inversely proportional to the second distance score, and the at least one specified element includes the another virtual object.

For example, when the specified element includes the another virtual object, if the position evaluation score is analyzed, a positional relative relationship between the first candidate position and the another virtual object needs to be analyzed. For example, the second distance between the first candidate position and an enemy virtual object or a teammate virtual object is determined. Using an example in which a smaller second distance indicates a stronger gain effect (inverse proportional relationship), a shorter second distance between the first candidate position and the enemy virtual object or the teammate virtual object indicates a higher second distance score, and the first candidate position is more helpful to summon the first virtual minion character.

In some embodiments, the second distance score corresponding to the enemy virtual object may alternatively be set higher, and the second distance score corresponding to the teammate virtual object may be set lower (that is, the first virtual minion character is more inclined to be summoned at a position close to the enemy virtual object); or the second distance score corresponding to the enemy virtual object may be set lower, and the second distance score corresponding to the teammate virtual object may be set higher (that is, the first virtual minion character is more inclined to be summoned at a position close to the teammate virtual object), or the like. This is not limited herein.

(3) A third distance score is obtained based on a third distance between the first candidate position and another virtual minion character.

In some embodiments, the third distance is inversely proportional to the third distance score, and the at least one specified element includes the another virtual minion character.

For example, when the at least one specified element includes another virtual minion character, if the position evaluation score is analyzed, a positional relative relationship between the first candidate position and the another virtual minion character needs to be analyzed. For example, the third distance between the first candidate position and the another virtual minion character is determined.

Using an example in which a smaller third distance indicates a stronger gain effect (an inverse proportion relationship), a smaller third distance between the first candidate position and another virtual minion character indicates a higher third distance score, and the first candidate position is more helpful to summon the first virtual minion character (the first virtual minion character is inclined to be summoned nearby the another virtual minion character); or using an example in which a smaller third distance indicates a weaker gain effect (a direct proportion relationship), a smaller third distance between the first candidate position and another virtual minion character indicates a lower third distance score, and the first candidate position is less helpful to summon the first virtual minion character (the first virtual minion character is inclined to be summoned at a position far from the another virtual minion character).

(4) An obstacle score is obtained based on a hindering effect of a virtual obstacle at the first candidate position on summoning the first virtual minion character.

The hindering effect is inversely proportional to the obstacle score, and the at least one specified element includes the virtual obstacle.

For example, when the specified element includes the virtual obstacle, if the position evaluation score is analyzed, the hindering effect of the virtual obstacle at the first candidate position on summoning the first virtual minion character needs to be analyzed, that is, whether the virtual obstacle exists at the first candidate position interfering with a character summoning process. If the virtual obstacle exists at the first candidate position interfering with the character summoning process, the hindering score is lower. For example, the hindering score is a value such as –1, –4, 0, or 1 (that is, may be a positive number, a negative number, or 0). If the virtual obstacle does not exist at the first candidate position interfering with the character summoning process, the interference score is higher. For example, the interference score is a value such as 3 or 5.

(5) A terrain score is obtained based on an influence degree of a virtual terrain at the first candidate position on summoning the first virtual minion character.

The influence degree is inversely proportional to the terrain score, and the at least one specified element includes the virtual terrain.

For example, when the at least one specified element includes the virtual terrain, if the position evaluation score is analyzed, the influence degree of the virtual terrain at the first candidate position on summoning the first virtual minion character needs to be analyzed, that is, whether the virtual terrain at the first candidate position affects a character summoning process. If the virtual terrain at the first candidate position affects the character summoning process (for example, the terrain is steep), the terrain score is lower. For example, the terrain score is a value such as –1, 0, or 1 (that is, may be a positive number, a negative number, or 0). If the virtual terrain at the first candidate position does not affect the character summoning process (for example, the terrain is flat), the terrain score is higher. For example, the terrain score is a value such as 2 or 5.

(6) A resource mining score is obtained based on a mining difficulty of mining a virtual resource by the first virtual minion character at the first candidate position.

The mining difficulty is inversely proportional to the resource mining score, and the at least one specified element includes the virtual resource.

For example, when the at least one specified element includes the virtual resource, if the position evaluation score is analyzed, the mining difficulty of the virtual resource at the first candidate position for the summoned first virtual minion character needs to be analyzed, that is, whether the first virtual minion character can effectively/efficiently mine the virtual resource at the first candidate position is determined. If the mining difficulty is lower (for example, the virtual resource is a deposit, and the first virtual minion character is good at mining the deposit), the resource mining score is higher. If the mining difficulty is higher (for example, the virtual resource is a deposit, the first virtual minion character is good at farming but not good at gathering resources; or the virtual resource is a deposit, and the first virtual minion character is good at mining wood), the resource mining score is lower.

(7) A place score is obtained based on a matching degree between the first virtual minion character and a virtual place at the first candidate position.

The matching degree is directly proportional to the place score, and the at least one specified element includes the virtual place.

For example, when the at least one specified element includes the virtual place, if the position evaluation score is analyzed, the matching degree between the first virtual minion character summoning at the first candidate position and the virtual place on a periphery needs to be analyzed, that is, whether the first virtual minion character can effectively use the virtual place at the first candidate position is determined. If the matching degree is lower (for example, the virtual place is a farm, and the first virtual minion character is good at a virtual attack), the place score is lower. If the matching degree is higher (for example, the virtual place is a farm, and the first virtual minion character is good at farming), the place score is higher, and the like.

At least one of the foregoing scores (the first distance score, the second distance score, the third distance score, the obstacle score, the terrain score, the resource mining score, and the place score) may be used as the position evaluation score. That is, a single score may be used as the position evaluation score, or a sum of a plurality of scores may be used as the position evaluation score (for example, the resource mining score is 6, the terrain score is –1, and a sum 5 of the scores is used as the position evaluation score). This is not limited herein.

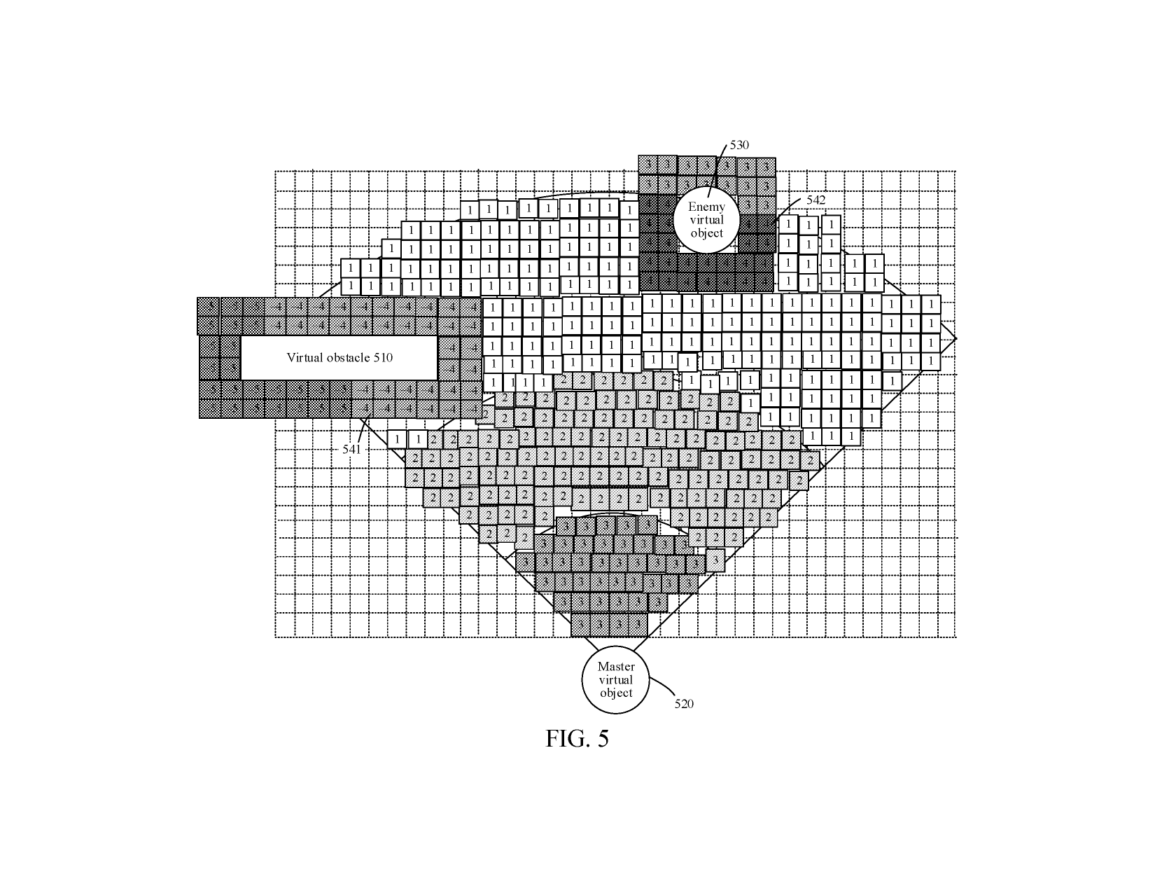

FIG. 5 is a schematic diagram of determining summoning matching data respectively corresponding to a plurality of candidate positions. A distance from a virtual obstacle 510 is used as a criterion for measuring the hindering effect, the obstacle score nearby the virtual obstacle 510 is –5. Using an example in which a smaller first distance from the master virtual object 520 indicates a higher first distance score, the first distance score includes 3, 2, and 1 (three regions are obtained through division by using arcs, to obtain three different first distance scores in FIG. 5). Using an example in which the second distance score is determined based on the second distance from the enemy virtual object 530, the second distance score is 3. A comprehensive obstacle score is –5, the first distance score includes 3, 2, and 1, the second distance score is 3, and a plurality of position evaluation scores are obtained as the summoning matching data.

As indicated by a candidate position 541, based on the obstacle score –5 and the first distance score 1, it is determined that the position evaluation score corresponding to the candidate position 541 is –4. As indicated by a candidate position 542, based on the second distance score 3 and the first distance score 1, it is determined that the position evaluation score corresponding to the candidate position 542 is 4, and the like. Details are not described herein again.

The foregoing describes several exemplary manners of obtaining the position evaluation score. The position evaluation score is, for example, at least one of the first distance score, the second distance score, the third distance score, the obstacle score, the terrain score, the resource mining score, and the place score. The foregoing different scores are determined by analyzing positional relative relationships between candidate positions and different specified elements from different perspectives, so that the position evaluation scores can be obtained as comprehensively and precisely as possible, thereby enabling a more detailed evaluation of advantages and disadvantages of each candidate position, to optimize a position selection effect. Further, the virtual minion character is summoned at the first position determined based on the position evaluation score, and the virtual minion character may be used to better assist the master virtual object in achieving a corresponding operation objective, such as better mining a virtual resource and attacking another virtual object more efficiently. This improves operation experience of the player, and facilitates improving operation efficiency of the player in controlling the master virtual object to perform different activities in the virtual scene.

The foregoing score values, score types, and the like are all merely exemplary examples, and are not limited in this embodiment of this application.

Operation 340: Determine, among the plurality of candidate positions, a candidate position whose corresponding summoning matching data meets a first matching requirement as a first position within the current field of view.

The first matching requirement is a condition requirement configured for constraining a candidate position based on the summoning matching data. In some embodiments, the first matching requirement is a preset matching requirement, for example, a preset matching data threshold; or the first matching requirement is a matching requirement flexibly changing based on an object level of the master virtual object, for example, a matching data interval whose value increases as the object level increases.

After the summoning matching data respectively corresponding to the plurality of candidate positions is obtained, each piece of summoning matching data is compared with the first matching requirement, and a candidate position meeting the first matching requirement is used as the first position, so that the first virtual minion character is displayed at the first position.

In an exemplary embodiment, the candidate position corresponding to a highest position evaluation score is determined as the first position.

For example, an example in which the position evaluation score is the summoning matching data is used, and the candidate position corresponding to the highest position evaluation score is used as the first position.

In some embodiments, when position evaluation scores respectively corresponding to at least two candidate positions are highest position evaluation scores, any one of the at least two candidate positions is used as the first position; or each of the at least two candidate positions is used as the first position; or a central point of a position region enclosed by the at least two candidate positions is used as the first position, or the like.

As shown in FIG. 5, after the position evaluation scores respectively corresponding to the plurality of candidate positions are obtained, it is determined that the highest position evaluation score is 4, and a candidate position is randomly selected from the candidate positions corresponding to 4 as the first position. For example, a candidate position 542 is selected as the first position.

In an exemplary embodiment, the candidate position whose position evaluation score exceeds a first score threshold is used as the first position.

For example, the first score threshold is a condition configured for evaluating the position evaluation score. In some embodiments, the first score threshold is a preset score threshold. For example, the first score threshold is preset to 5. Position evaluation scores respectively corresponding to the plurality of candidate positions are compared with the first score threshold, and a candidate position whose position evaluation score exceeds 5 is used as the first position. In some embodiments, the first score threshold may alternatively be a score threshold determined based on an object position corresponding to the master virtual object. For example, when the master virtual object is in the region A, the first score threshold is 3, and when the master virtual object is in the region B, the first score threshold is 5. This is not limited herein.

In some embodiments, when there are a plurality of candidate positions whose position evaluation scores exceed the first score threshold, one or more candidate positions are randomly selected from the plurality of candidate positions as the first positions.

After the first position is determined, the first virtual minion character on which the character summoning operation is performed is displayed at the first position.

The foregoing describes the content of determining the first position based on the position evaluation score. If the candidate position having the highest position evaluation score is used as the first position, selection of the first position has uniqueness and is more targeted, thereby avoiding a selection burden of the player voluntarily selecting the first position. An optimal first position can be found through intuitively quantified position evaluation scores to summon the virtual minion character, thereby improving player experience and player operation efficiency. In addition, if the candidate position meeting a condition is filtered as the first position by using the first score threshold, a minimum score criterion may be defined to exclude a candidate position that significantly does not meet a requirement, to flexibly adapt to different scenarios or player requirements. This better optimizes an implementation effect of the first position, improves character summoning experience of the player, ensures selection of the first position is highly targeted, and optimizes resource utilization of character selection.

In an exemplary embodiment, in response to the character summoning operation when a second virtual minion character exists within the current field of view, the second virtual minion character moves to the first position is displayed.

The second virtual minion character includes at least one of the following virtual minion characters.

(1) The second virtual minion character and the master virtual object are both in a first virtual camp.

For example, the character summoning operation may summon a virtual minion character in the virtual backpack to the virtual scene, and may summon a virtual minion character that is not at the first position and that is in the virtual scene to the first position in the virtual scene. When the second virtual minion character exists within the current field of view, and the second virtual minion character and the master virtual object are both in the first virtual camp, for example, the second virtual minion character is a virtual minion character captured by the master virtual object, or the second virtual minion character is a virtual minion character captured by a teammate virtual object of the master virtual object, that is, it is considered that the second virtual minion character and the master virtual object are in the same first virtual camp, the second virtual minion character may be summoned to the first position.

(2) The master virtual object is in a first virtual camp, the second virtual minion character is in a second virtual camp, and a first team level of the first virtual camp is higher than a second team level of the second virtual camp.

For example, when the second virtual minion character exists within the current field of view, even if the second virtual minion character and the master virtual object are in different virtual camps, if the first team level of the first virtual camp is higher than the second team level of the second virtual camp, the master virtual object may compete for the ownership of the second virtual minion character, and summon the second virtual minion character obtained through the competition to the first position.

The team level includes a level of a virtual camp, or the team level includes a level of a virtual captain in the virtual camp; or the team level includes an average of a plurality of levels of all teammate virtual objects (including the master virtual object) in the virtual camp, and the like, which is not limited herein.

In some embodiments, when the master virtual object does not capture a virtual minion character, the master virtual object may summon the second virtual minion character to the first position based on the character summoning operation; or when the master virtual object preferentially selects not to use a captured virtual minion character, the master virtual object may summon the second virtual minion character to the first position based on the character summoning operation, or the like.

The foregoing describes the content of moving the second virtual minion character to the first position, where the second virtual minion character is a virtual minion character summoned to the first position. Interactivity and a policy depth in a game can be enhanced with reference to a camp and team level of a virtual minion character. The process ensures a dynamic response between a behavior of a virtual minion character in the game and an operation of the player, provides a more immersive picture effect, also improves strategy and law richness of the game, and improves the efficiency of human-computer interaction.

In an exemplary embodiment, the first virtual minion character is controlled to perform an exploration activity in the virtual scene.

For example, the first virtual minion character may be automatically controlled to perform an exploration activity in the virtual scene; or the first virtual minion character is controlled, based on the character control operation of the player, to perform the exploration activity in the virtual scene, or the like.

The foregoing descriptions are merely exemplary examples, and are not limited in this embodiment of this application.

In this embodiment of this application, the content of obtaining the summoning matching data corresponding to the candidate position and selecting the first position is described. The plurality of candidate positions are selected within the current field of view based on the position selection rule, then a positional relationship of each candidate position relative to the at least one specified element is analyzed, and the summoning matching data respectively corresponding to the plurality of candidate positions is obtained. The summoning matching data can reflect the gain effect of summoning the first virtual minion character at the candidate position to some extent, so that the first position suitable for summoning the first virtual minion character can be more precisely and properly selected from the plurality of candidate positions by using the summoning matching data, thereby improving a determining effect and determining precision of the first position, and improving the efficiency of human-computer interaction.

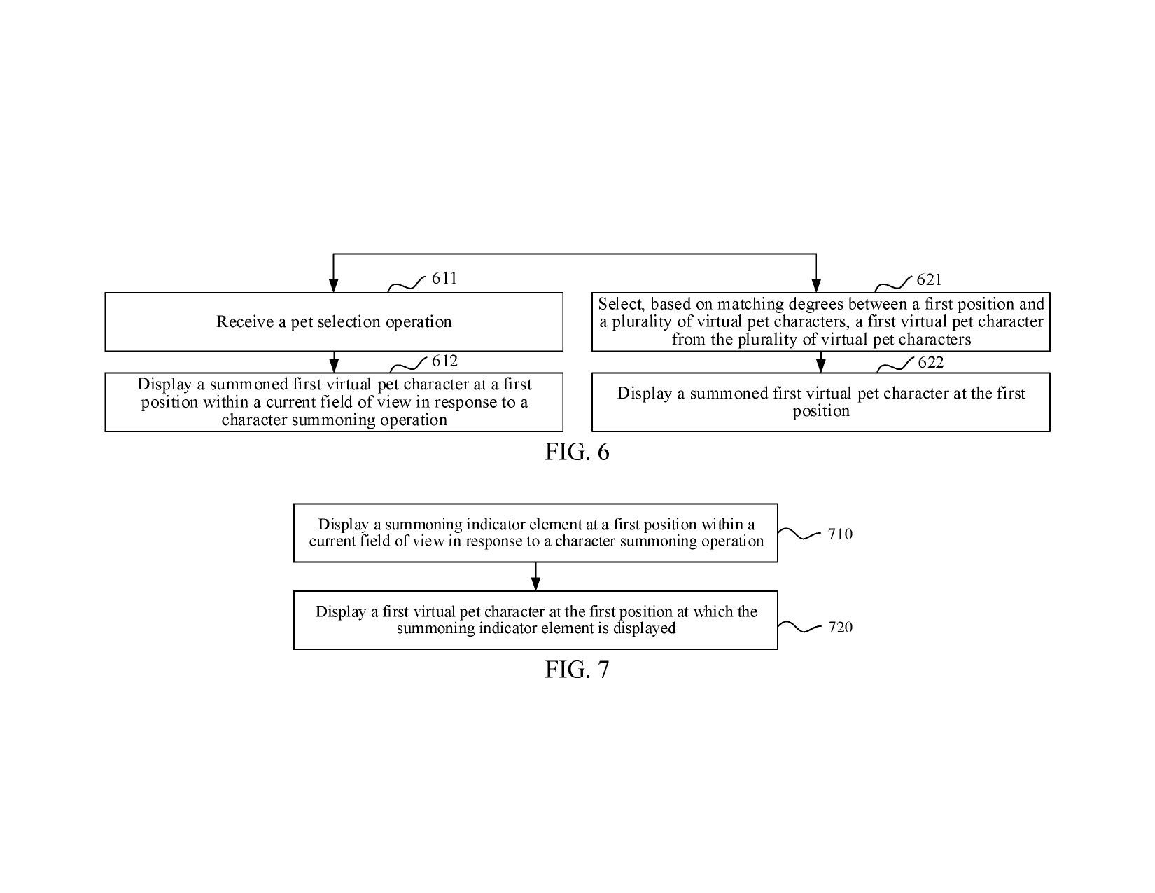

In an exemplary embodiment, the first virtual minion character as the selected virtual minion character may be a virtual minion character manually selected by the player, or may be a virtual minion character automatically selected from a plurality of candidate virtual minion characters selected in advance after the character summoning operation is received. FIG. 6 is a flowchart of selecting a first virtual minion character according to an exemplary embodiment of this application. For example, as shown in FIG. 6, the embodiment shown in FIG. 2 may further include operation 611 to operation 622.

Operation 611: Receive a pet selection operation.

The pet selection operation is configured for selecting the first virtual minion character from at least one virtual minion character possessed by the master virtual object. The at least one virtual minion character is a virtual minion character captured from the virtual scene based on a pet capture operation.

For example, the master virtual object obtains the at least one virtual minion character by capturing, and may store the virtual minion character in the virtual backpack.

The pet selection operation is implemented based on a selection operation for the first virtual minion character in the at least one virtual minion character that is possessed from the virtual backpack; or at least one virtual minion character is selected from the virtual backpack in advance as a candidate virtual minion character (the candidate pet character is a virtual minion character that can implement a summoning function, and a virtual minion character in the virtual backpack cannot be summoned based on the summoning function), and the pet selection operation is implemented based on a selection operation of the first virtual minion character in the at least one possessed and selected candidate virtual minion character.

In some embodiments, the pet selection operation is implemented before the character summoning operation.

The foregoing describes the content of selecting the summoned first virtual minion character by using the pet selection operation. The process combines the pet selection operation and the summoning process, thereby enhancing interactivity and strategy of the game. When the player captures a virtual minion character to expand a pet lineup, the player may select, by using the pet selection operation, the first virtual minion character that needs to cooperate with interaction of the player in the virtual scene, thereby improving gameplay diversity in a game process, enhancing game playability and immersion, and improving accuracy of selecting the virtual minion character.

In an exemplary embodiment, at least one character identifier is displayed when the character summoning operation is received. The at least one character identifier is in a one-to-one correspondence with the at least one virtual minion character. For example, an example in which the character summoning operation is implemented after the pet selection operation is used. When the character summoning operation is received, the at least one character identifier in a one-to-one correspondence with the at least one possessed virtual minion character is displayed, and the at least one virtual minion character is a virtual minion character that can be summoned based on the summoning capability (or a virtual minion character that cannot be summoned based on the summoning capability is in an unselectable state).

In an exemplary embodiment, a selection operation for a first character identifier in the at least one character identifier is received as the pet selection operation. The first character identifier is a character identifier corresponding to the first virtual minion character.

For example, if the selection operation is performed on the first character identifier, it is considered that the pet selection operation is implemented, and the first virtual minion character corresponding to the first character identifier is used as a virtual minion character selected by the pet selection operation.

The foregoing describes the content of selecting the summoned virtual minion character by selecting the character identifier. Based on the one-to-one correspondence between the at least one character identifier and the at least one virtual minion character, the player can select and manage the virtual minion character more intuitively and quickly, thereby reducing interaction complexity of the player, making character selection more efficient and precise, and ensuring accuracy of selection of the player. Therefore, smoothness of user experience and intuitiveness of operations are improved, a sense of control of the player over the virtual minion character is enhanced, and accuracy of operations is ensured.

Operation 612: Display a summoned first virtual minion character at a first position within a current field of view in response to the character summoning operation.

The first position is dynamically determined based on an element position of at least one specified element within the current field of view.

For example, the first virtual minion character selected by the pet selection operation is displayed at the first position based on the character summoning operation.

Operation 621: Select, based on matching degrees between the first position and a plurality of virtual minion characters, the first virtual minion character from the plurality of virtual minion characters.

The plurality of virtual minion characters are virtual minion characters within a capability summoning range of a summoning capability of the master virtual object. For example, the master virtual object has the summoning capability, and the summoning capability is a capability of summoning a virtual minion character in the virtual scene. The capability summoning range is a range covered by the summoning capability. A corresponding summoning process may be performed on the virtual minion character within the capability summoning range based on the summoning capability.

In some embodiments, the capability summoning range includes a specific space range in the virtual scene, and in this case, the capability summoning range refers to a three-dimensional space range. The capability summoning range may be preset in the game, may be obtained from the virtual scene based on a task completion status of the master virtual object (for example, if a task R is completed, a region R1 in the virtual scene is used as the capability summoning range), may be automatically determined based on an object position of the master virtual object (for example, a region within a range of a radius of 1 m around the object position at which the master virtual object is located is used as the capability summoning range), or the like.

In some embodiments, the capability summoning range includes a character range of the virtual minion character. For example, the capability summoning range is irrelevant to the three-dimensional space range indicated by the virtual scene, and represents a character range of the virtual minion character that can be summoned. For example, the capability summoning range is a virtual minion character possessed by the master virtual object; or the capability summoning range is a virtual minion character possessed by a virtual camp that the master virtual object is in (for example, the capability summoning range includes a virtual minion character possessed by a teammate virtual object); or the capability summoning range is a virtual minion character possessed by an enemy virtual camp eliminated by the master virtual object (for example, the capability summoning range includes a virtual minion character possessed by an eliminated enemy virtual object D), or the like.

A form in which the capability summoning range is implemented as a three-dimensional space range or a character range is merely an exemplary example, and one or a combination of the capability summoning ranges may be selected for use, which is not limited herein.

For example, after the first position is dynamically determined based on the element position of the at least one specified element within the current field of view, the first position is matched, based on the capability summoning range corresponding to the summoning capability, with a plurality of virtual minion characters that can be summoned by the master virtual object. The capability summoning range includes a character range in which the virtual minion character can be summoned (for example, a virtual minion character possessed in advance by the master virtual object is summoned) and that is pointed by the summoning capability, a three-dimensional space range in which the virtual minion character can be summoned (for example, a virtual minion character located within a region A can be summoned) and that is pointed by the summoning capability, and the like. Based on a matching process, the matching degrees respectively corresponding to the plurality of virtual minion characters are obtained.

In an exemplary embodiment, the first position is matched with the plurality of virtual minion characters based on character attributes respectively corresponding to the plurality of virtual minion characters and the position parameter of the first position, to obtain the matching degrees respectively corresponding to the plurality of virtual minion characters.

The character attribute includes at least one of an assistance attribute, a counter attribute, or a gathering attribute of the virtual minion character, and the position parameter includes at least one of a position parameter, an obstacle parameter, a terrain parameter, a resource parameter, or an additional assignment parameter between a candidate position and a virtual object. For example, the assistance attribute represents assistance strength (for example, assistance strength in terms of a virtual attack is 20%, and/or assistance strength in terms of virtual magic is 10%) of the virtual minion character for the master virtual object at the first position. The counter attribute represents counter strength of the virtual minion character for an enemy virtual object (for example, a speed at which the enemy virtual object can be countered to reduce to 50%) at the first position. The gathering attribute represents gathering strength of the virtual minion character for the virtual resource (for example, the virtual resource is gathered completely within 3 minutes) at the first position.

For example, the position parameter includes at least one of position conditions between the first position and the master virtual object, another virtual object, and another virtual minion character; the obstacle parameter represents an influence degree of a virtual obstacle at the first position on summoning a virtual minion character; the terrain parameter represents an influence degree of a virtual terrain at the first position on summoning a virtual minion character; the resource parameter represents resource mining difficulty of a virtual terrain at the first position for summoning a virtual minion character; and the additional assignment parameter represents an influence degree of various other resources for summoning a virtual minion character at the first position, and the like.

In some embodiments, the character attributes of the plurality of virtual minion characters are comprehensively compared with the position parameter of the first position, to implement a matching process and obtain a plurality of matching degrees. For example, the resource parameter of the first position indicates that a virtual deposit exists and a total amount is 9 kg. The gathering attribute corresponding to the virtual minion character 1 represents that a speed of gathering the virtual deposit is 3 kg/min, and the gathering attribute corresponding to the virtual minion character 2 represents that a speed of gathering the virtual deposit is 4 kg/min. Therefore, a matching degree of the virtual minion character 2 is higher than a matching degree of the virtual minion character 1.

In an exemplary embodiment, at least one virtual minion character whose matching degree meets a second matching requirement is determined as the first virtual minion character.

The second matching requirement is used as a condition for analyzing a matching degree. For example, the second matching requirement is a preset matching degree threshold; or the second matching requirement is a preset rule (for example, an average value of a plurality of matching degrees); or the second matching requirement is information determined based on an object level of the master virtual object, and is not limited herein.

For example, at least one virtual minion character having the highest matching degree is used as the first virtual minion character; or at least one virtual minion character having a matching degree higher than a preset matching threshold is used as the first virtual minion character.

The foregoing describes the content of matching the first position with the virtual minion character to determine the matching degree. A relationship between the first position and the virtual object is analyzed in the matching process by comprehensively considering a plurality of dimensions, thereby ensuring high conformity between the virtual minion character and the first position, avoiding a mismatching situation, and improving interactivity in a virtual scene. This facilitates meeting a player requirement (such as a resource mining requirement or an attack requirement) by summoning the virtual minion character to the first position, thereby improving the efficiency of human-computer interaction. In addition, a virtual minion character having a matching degree meeting the second matching requirement is selected for summoning, so that character selection efficiency is optimized, and redundant selection or resource waste is avoided, thereby enabling an interaction operation to be more precise and efficient.

Operation 622: Display the summoned first virtual minion character at the first position.

For example, the first virtual minion character is automatically selected based on the matching process, so that the summoned first virtual minion character is displayed at the first position.

The foregoing descriptions are merely exemplary examples, and are not limited in this embodiment of this application.

In this embodiment of this application, a method for selecting a first virtual minion character is described. The first virtual minion character that needs to be summoned may be manually selected by the player by using the pet selection operation, thereby improving targeting of character summoning. The first virtual minion character may be further automatically selected, based on the matching degrees between the first position and the plurality of virtual minion characters, from the plurality of virtual minion characters captured by the master virtual object, so that more targeted exploration is performed on a periphery of the first position by using the first virtual minion character, thereby improving character summoning flexibility and lowering an operation threshold, and improving enjoyment of the game and the efficiency of human-computer interaction.

In an exemplary embodiment, before the first virtual minion character is displayed at the first position, a summoning indicator element configured for prompting pet character summoning is displayed at the first position based on the character summoning operation, and the first virtual minion character is displayed at the first position at which the summoning indicator element is displayed. FIG. 7 is a flowchart of displaying a first virtual minion character at a position of a summoning indicator element according to an exemplary embodiment of this application. For example, as shown in FIG. 7, operation 230 shown in FIG. 2 may further be implemented as operation 710 to operation 720 below.

Operation 710: Display a summoning indicator element at a first position within a current field of view in response to a character summoning operation.

The summoning indicator element is configured for prompting summoning of a virtual minion character.

For example, the summoning indicator element may be considered as a character summoning special effect, representing that a character summoning process needs a waiting time. In some embodiments, the summoning indicator element may alternatively be disabled based on manual setting of the player. Display of the summoning indicator element is not limited herein.

In an exemplary embodiment, a virtual light beam is displayed as the summoning indicator element at the first position within the current field of view in response to the character summoning operation. For example, the virtual light beam is an exemplary element special effect. For example, the virtual light beam is a light beam vertically emitted from a virtual ground at the first position to a virtual sky. Alternatively, for example, the virtual light beam is a light beam standing on the virtual ground with a first height at the first position. For example, the first height is a preset height or a height determined based on rarity of the first virtual minion character (for example, a rarer first virtual minion character indicates a larger first height).

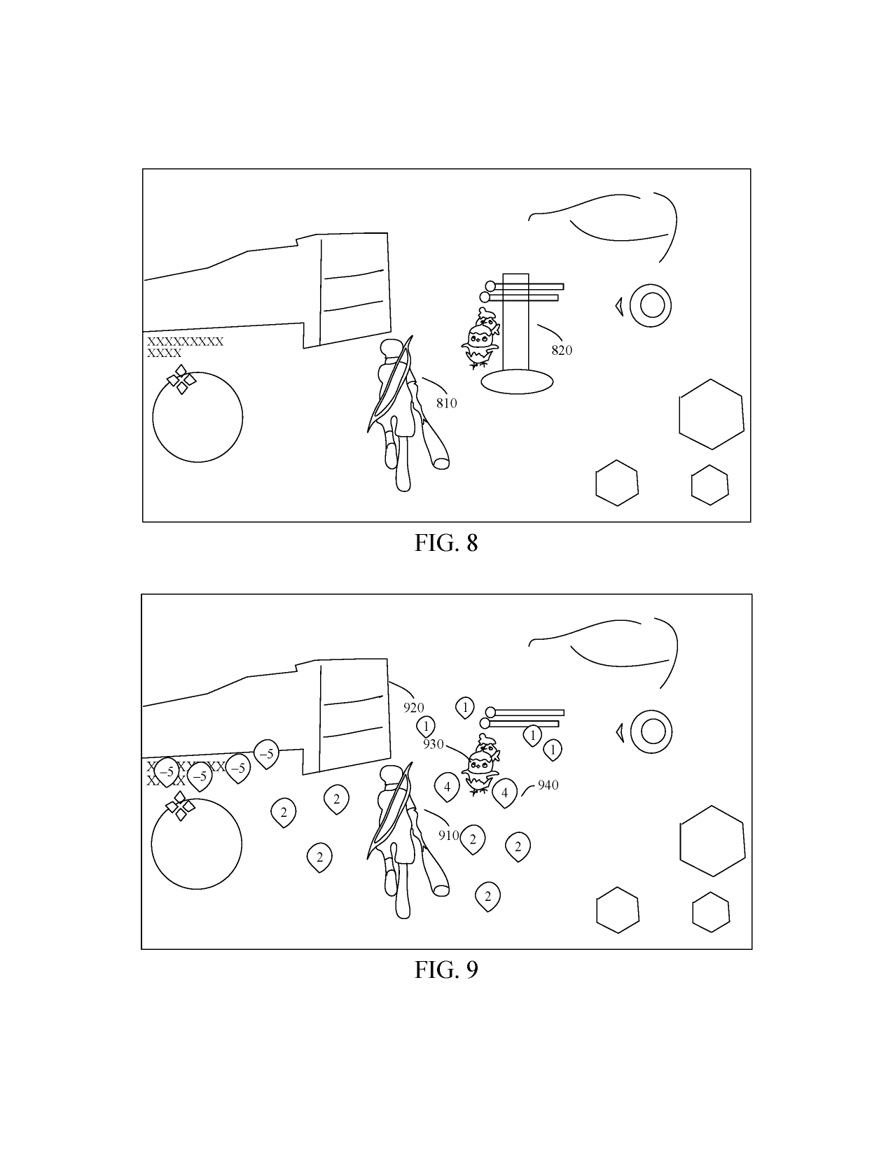

FIG. 8 is a schematic diagram of displaying a virtual light beam as a summoning indicator element.

A master virtual object 810 moves in the virtual scene, and if the first position is determined, a virtual light beam 820 is displayed at the first position.

In an exemplary embodiment, a virtual curtain is displayed as the summoning indicator element at the first position within the current field of view in response to the character summoning operation.

For example, the virtual curtain is another exemplary element special effect. For example, the virtual curtain may be in a closed state, an open state, or the like. In addition, another virtual identifier, a virtual arrow, or the like may alternatively be used as the summoning indicator element, which is not limited herein.

In an exemplary embodiment, based on a positional relative relationship between the candidate positions and the at least one specified element in response to the character summoning operation, a gain effect of summoning the first virtual minion character at the candidate positions is evaluated, to obtain position evaluation scores respectively corresponding to the plurality of candidate positions as the summoning matching data; and the first position is determined from the plurality of candidate positions based on the position evaluation scores.

In some embodiments, the candidate position corresponding to a highest position evaluation score is used as the first position.

For example, when a plurality of highest position evaluation scores exist, candidate positions respectively corresponding to the plurality of highest position evaluation scores are determined, one candidate position is randomly selected therefrom as the first position, and the summoning indicator element is displayed (for example, a virtual light beam is displayed) at the first position. Alternatively, a position region is surrounded based on a candidate position corresponding to the highest position evaluation score, a position is randomly selected from the position region as the first position, and the summoning indicator element is displayed at the first position (for example, a virtual light beam is displayed). Alternatively, the summoning indicator element may be displayed at the position region, where a center of the summoning indicator element is at the first position, or the like.

As shown in FIG. 9, a master virtual object 910, a virtual obstacle 920, and another virtual object 930 are included. Based on distribution of the specified elements, the position evaluation scores, such as scores –5, 2, 4, and 1, respectively corresponding to the plurality of candidate positions are determined. The position evaluation scores may be displayed on a terminal interface, or may be only for backend data analysis and not displayed on the terminal interface, which is not limited herein. As shown in FIG. 9, the highest position evaluation score is 4, and corresponds to two candidate positions. One candidate position may be randomly selected from the two candidate positions as the first position. For example, a candidate position 940 is randomly used as the first position.

Operation 720: Display the first virtual minion character at the first position at which the summoning indicator element is displayed.

For example, after the summoning indicator element is displayed, the summoned first virtual minion character is displayed at the first position at which the summoning indicator element is located.

In some embodiments, when the display duration of the summoning indicator element reaches preset duration, the summoned first virtual minion character is displayed at the first position at which the summoning indicator element is located. For example, the preset duration is 2 seconds. When the display duration of the summoning indicator element reaches 2 seconds, the summoned first virtual minion character is displayed at the first position, and the summoning indicator element may be considered as duration required for summoning.

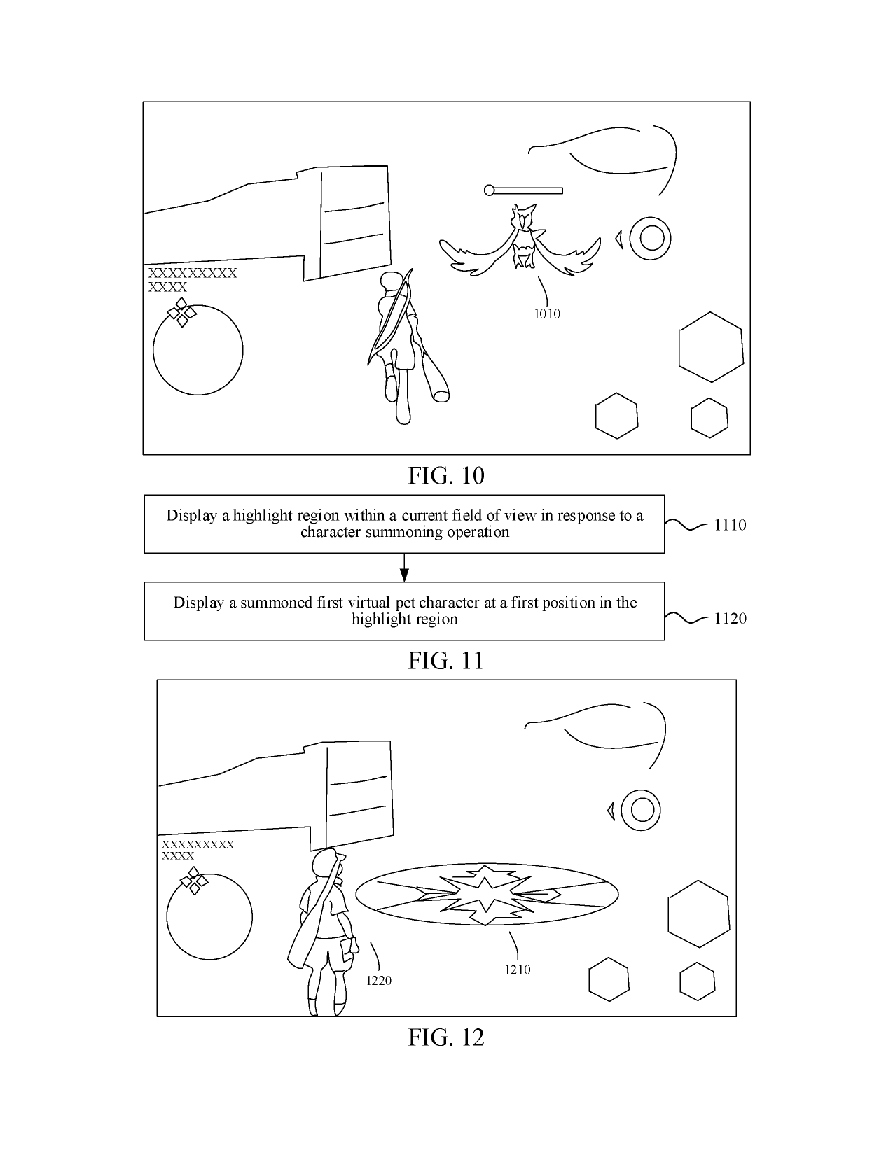

Based on that the virtual light beam 820 shown in FIG. 8 is used as the summoning indicator element, the first virtual minion character is displayed at the first position at which the virtual light beam 820 is located, and a schematic diagram of an interface shown in FIG. 10 is displayed. A first virtual minion character 1010 is displayed at the first position at which the summoning indicator element is displayed previously.

The foregoing descriptions are merely exemplary examples, and are not limited in this embodiment of this application.

In this embodiment of this application, the content of displaying the first virtual minion character after the summoning indicator element is displayed is described. A prompt effect is provided for summoning the first virtual minion character by using the summoning indicator element, to remind the player that the first virtual minion character may be summoned at the first position. This also corresponds to a situation in which the character summoning has specific duration, thereby improving a picture display effect and picture display richness of the character summoning, and improving reality of the game. In addition, the summoning indicator element also provides clear operation feedback for the player, to ensure that the summoned virtual minion character and the summoning indicator element can be presented smoothly and without a delay, thereby ensuring utilization efficiency of computing resources, and helping improve the efficiency of human-computer interaction.

The summoning indicator element is implemented in a form of a virtual light beam, a virtual curtain, or the like, so that the summoning indicator element that is more vivid and has visual impacts may be displayed at the first position based on the character summoning operation, to prompt that the first position at which the virtual minion character is to be summoned. This prevents another interface element from interfering with operation experience of the player while providing good visual guidance for the player, thereby ensuring the operation efficiency of the player.

In an exemplary embodiment, before the first virtual minion character is displayed at the first position, a highlight region is displayed within the current field of view based on the character summoning operation, and the first virtual minion character is displayed at the first position within the highlight region. FIG. 11 is a flowchart of displaying a first virtual minion character at a first position in a highlight region according to an exemplary embodiment of this application. For example, as shown in FIG. 11, operation 230 shown in FIG. 2 may further be implemented as operation 1110 and operation 1120 below.

Operation 1110: Display a highlight region within the current field of view in response to the character summoning operation.

The highlight region is configured for representing a character summoning range of the first virtual minion character, the character summoning range is a range in which the first virtual minion character is effectively summoned to the virtual scene and is controlled by the master virtual object, and the character summoning range is a three-dimensional space range determined based on the current field of view in the virtual scene.

For example, the highlight region is a special effect region displayed in the virtual scene, and the highlight region may be a circle, a rectangle, a sphere, an irregular shape, or the like. This is not limited herein.

In some embodiments, the range within which the first virtual minion character can be summoned is further refined by using the highlight region within the current field of view, and the first virtual minion character is displayed within the current field of view and is further displayed within the highlight region of the current field of view.

In an exemplary embodiment, the highlight region is displayed within the current field of view in response to receiving a position selection operation when the character summoning operation is received.

The position selection operation is configured for selecting, within the current field of view, a region display position of the highlight region.

For example, the position selection operation is an operation received at the same time when the character summoning operation is received. For example, a current game is a computer game that can be operated by using both a touch screen and a peripheral device. The character summoning operation is a long-press operation on a character summoning control. In a process of the long-press operation, the position selection operation is implemented by dragging a mouse, and the highlight region is displayed within the current field of view.

For example, the position selection operation is an operation received within preset operation duration after the character summoning operation is received. For example, the character summoning operation is a click/tap operation on the character summoning control, and the preset operation duration is 3 seconds. If a position selection operation such as dragging a mouse or sliding a terminal screen is received within 3 seconds, the highlight region is displayed within the current field of view, or the like.

In some embodiments, in response to receiving the position selection operation pointing to a first display position within the current field of view, a preset circular region with the first display position as a circle center is displayed as the highlight region.

For example, if the position selection operation points to the first display position within the current field of view, the preset circular region is displayed as the highlight region with the first display position as the circle center and a preset display radius as a circular region radius. For example, a blue circular region is displayed as the highlight region; or a red circular region is displayed as the highlight region, or the like.

In some embodiments, in response to receiving the position selection operation pointing to a first display position within the current field of view, a preset rectangular region with the first display position as a center is displayed as the highlight region; or an irregular region displayed with the first display position as a center of gravity is displayed as the highlight region, or the like. An appearance style such as a color and a shape of the highlight region is not limited herein.

FIG. 12 is a schematic diagram of an interface of displaying a highlight region. When the player performs the character summoning operation, the player may drag, by using a mouse, a lighted highlight region 1210 to move on a virtual ground, and the highlight region 1210 is located within a current field of view of a master virtual object 1220.

In some embodiments, in response to receiving the position selection operation to circle a user-defined region in the virtual scene, the user-defined region is used as the highlight region, that is, the user-defined region is displayed in a highlighted form.

For example, the position selection operation may be implemented by selecting a display position (for example, a position point), or may be implemented by circling an independent region in the virtual scene, for example, circling in the virtual scene to obtain a circular region, an elliptic region, or the like as the selected user-defined region; or an irregular region is arbitrarily defined in the virtual scene as the user-defined region, or the like. After being selected, the user-defined region is presented in a highlighted form, that is, the content of displaying the highlighted region based on the position selection operation is implemented.

The foregoing describes the content of determining the highlight region based on the position selection operation. When the character summoning operation is received, a region configured for summoning a virtual minion character may be defined by using the position selection operation. The selected region is located within the current field of view, and is selected by the player, thereby ensuring specific autonomy of the player and precision of region selection, and avoiding misoperation or invalid selection of the player. In addition, the region determined based on the position selection operation is displayed in a highlighted form, to visually present an effective summoning position selected by the player, thereby improving fault tolerance of operation and the sense of control of the player, and ensuring that the virtual minion character can still be summoned in real time and efficiently in complex scenes.

In addition, the foregoing describes the content of determining the highlight region based on the position selection operation. If the position selection operation points to the first display position, a preset circular region, a preset rectangular region, or the like may be displayed as the highlight region based on the first display position, to avoid a limitation of merely summoning the first virtual minion character at the first display position. The highlight region can assist the player in summoning the first virtual minion character at a more proper position. In addition, the position selection operation may be further implemented as a user-defined region selected by the player, to ensure a personalized feature in a process in which the player summons the virtual minion character, thereby helping improve the efficiency of human-computer interaction.

In an exemplary embodiment, the highlight region is displayed within the current field of view in response to the character summoning operation when a first summoning function is enabled. The first summoning function is a function of selecting, within the current field of view, a character summoning range configured for summoning the first virtual minion character.

In some embodiments, the first summoning function is a function built in a setting control. In a game process, the highlight region may be displayed within the current field of view by enabling the first summoning function in the setting control; or the first summoning function is enabled by using the setting control before the game starts, and the highlight region may be displayed within the current field of view, or the like.

The foregoing describes that the first summoning function is used as a condition for determining the character summoning range. If the first summoning function is enabled, the player may select, based on the character summoning operation, a specific region from a field of view as a region for summoning the virtual minion character, and the region is displayed in a highlighted form (that is, the highlight region). The manner of displaying in a highlighted form enables the user to observe an available summoning region in time, thereby improving clarity and intuitiveness of an operation process. In addition, the manner of selecting a highlight region to summon a virtual minion character also improves interaction precision and smoothness, so that the player can obtain a higher degree of freedom in the virtual scene, confusion caused by unclear character summoning ranges is reduced, interactivity of the character summoning operation is greatly optimized, waste of computing resources is effectively reduced, and real-time and accuracy of operations of the player are ensured, thereby providing better user experience.

Operation 1120: Display the summoned first virtual minion character at a first position in the highlight region.

For example, after the highlight region is determined, the summoned first virtual minion character may be displayed at the first position in the highlight region. The first position is a position determined based on a positional relative relationship between at least one candidate position in the highlight region and the at least one specified element.

In an exemplary embodiment, the at least one candidate position located in the highlight region is determined.

For example, the at least one candidate position is a candidate position located within the highlight region. For example, the at least one candidate position is a candidate position selected from a plurality of candidate positions within the current field of view based on the highlight region; or at least one candidate position is directly randomly selected from the highlight region; or at least one candidate position is selected from the highlight region based on the position selection rule.

In an exemplary embodiment, based on the positional relative relationship between the at least one candidate position and the at least one specified element, a gain effect of summoning the first virtual minion character at the at least one candidate position is evaluated, to obtain summoning matching data respectively corresponding to the at least one candidate position. For example, the at least one specified element includes at least one of a plurality of virtual elements such as a virtual obstacle, a virtual resource, a virtual terrain, and a virtual object. A positional relative relationship between each candidate position and the at least one specified element is analyzed, to evaluate a gain effect of summoning the first virtual minion character at the candidate position, and obtain the summoning matching data respectively corresponding to the at least one candidate position.

In some embodiments, the gain effect of summoning the first virtual minion character at each candidate position is evaluated, to obtain a position evaluation score corresponding to each candidate position as the summoning matching data. For content of the position evaluation score obtained herein, refer to operation 330. Details are not described herein again.

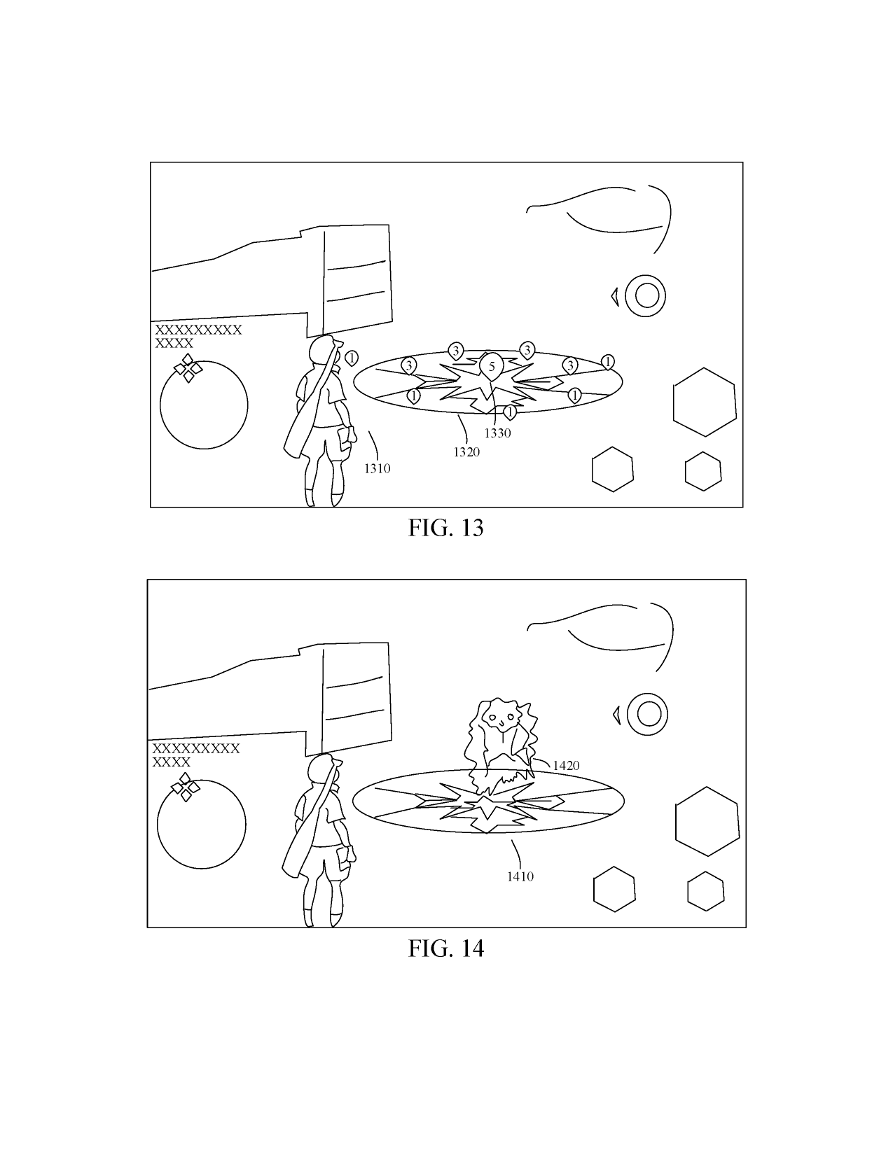

In some embodiments, the summoning matching data in the highlight region may be summoning matching data within the current field of view; or may be redetermined based on a positional relationship between the candidate position in the highlight region and a virtual element. This is not limited herein. As shown in FIG. 13, a highlight region 1320 is determined within a current field of view of a master virtual object 1310, and score evaluation is respectively performed based on a plurality of candidate positions in the highlight region 1320, to obtain position evaluation scores, such as 1, 3, and 5, respectively corresponding to the plurality of candidate positions. The position evaluation score may be displayed on a terminal interface, or may be used as backend data reference and not displayed on the terminal interface. This is not limited herein.

In an exemplary embodiment, the first position is determined based on the summoning matching data, and the summoned first virtual minion character is displayed at the first position. For example, a candidate position corresponding to the highest summoning matching data is used as the first position, and the summoned first virtual minion character is displayed at the first position. For example, an example in which the summoning matching data is the position evaluation score is used. The candidate position corresponding to a highest position evaluation score is used as the first position. As shown in FIG. 13, a candidate position 1330 corresponding to a highest position evaluation score 5 is used as the first position.

FIG. 14 is a schematic diagram of an interface of displaying a first virtual minion character at a first position in a highlight region. Based on analysis of the summoning matching data, a first virtual minion character 1420 is displayed at a first position in the highlight region 1410.

The foregoing describes that the summoning matching data obtained by evaluating the gain effect through the positional relative relationship is used as information for determining the first position. This manner intelligently implements a process of summoning a virtual minion character. The summoning matching data determined by using the gain effect helps the player to select a more proper first position from the highlight region, thereby ensuring that the summoning of the virtual minion character meets a requirement of the player and maximizes an effect of the virtual minion character. Such an automatic analysis process improves precision of determining the first position, helps the player to make a more strategic decision based on the virtual scene, reduces operation complexity, and enables the player to control more precisely summoning and deployment of a virtual minion character, thereby improving immersion and user experience of the game.

The foregoing descriptions are merely exemplary examples, and are not limited in this embodiment of this application.

In this embodiment of this application, the content of selecting the highlight region and displaying the first virtual minion character at the first position in the highlight region is described. By enabling the highlight region, a manual selection process of the player may be introduced into the process of automatically determining the first position, to refine selection precision of the first position, and provide autonomy to a game process of the player while lower an operation threshold. This helps to make the selection of the first position better more in line with a game mindset of the player, improves game flexibility, rational use of calculation resources, and resource utilization, and improves the efficiency of human-computer interaction.

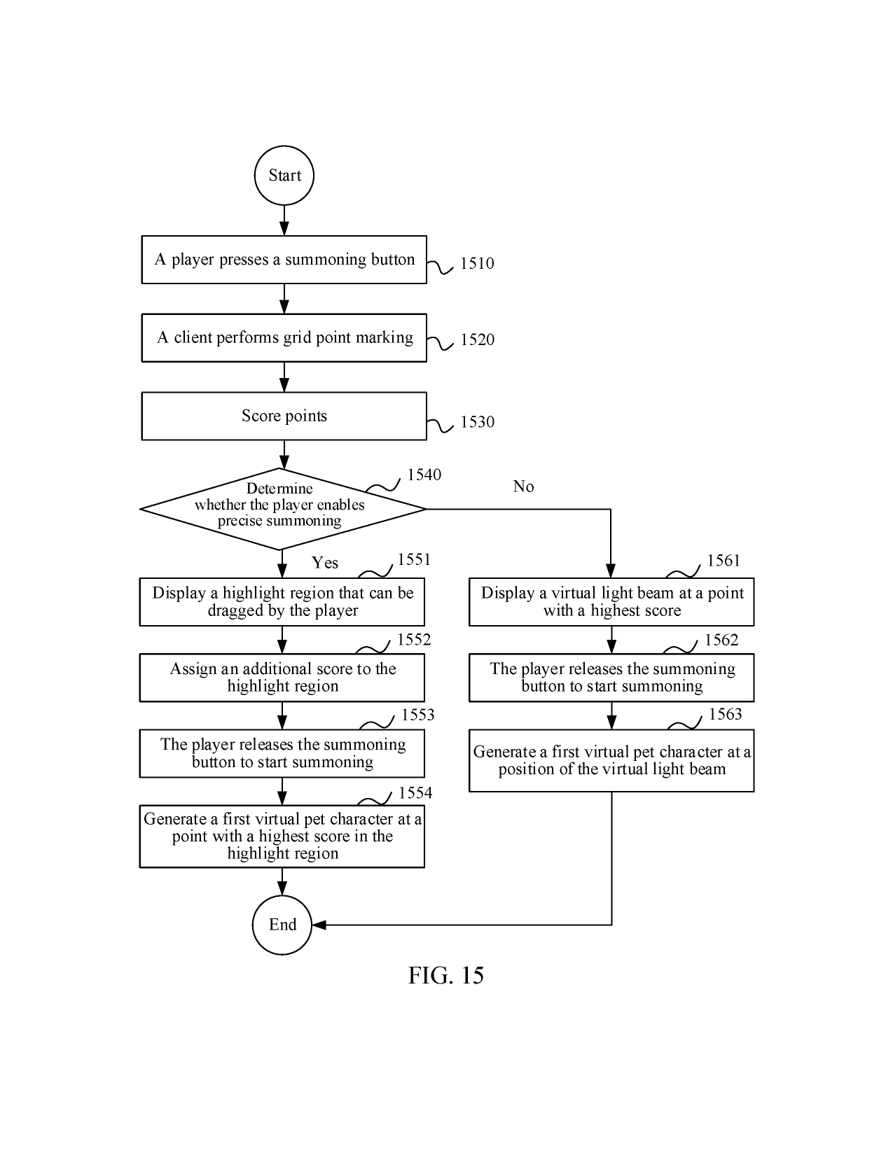

In an exemplary embodiment, the foregoing method for summoning a virtual minion character may also be referred to as a solution of summoning a virtual minion character at a selected point based on a lens orientation. FIG. 15 is a schematic flowchart of summoning, which includes the following operations.

Operation 1510: A player presses a summoning button in the graphical user interface.

For example, the summoning button is a character summoning control, configured to implement the character summoning operation, to summon the first virtual minion character. A summoning signal is received based on triggering of the summoning button, so that a summoning process is started.

Operation 1520: A client performs grid point marking.

For example, the client may be understood as a terminal running a game, or may be understood as a game application program installed on a terminal. The grid point marking is performed by the client, that is, a candidate position selection is performed by using a preset grid size as a position selection rule.

In some embodiments, the client defines a sectoral region based on an orientation of a virtual camera and provides configurations such as a sectoral size, an angle, and a grid size. The sectoral region is divided into a plurality of small grid regions according to a preset configuration (the position selection rule), and each small grid region corresponds to a candidate position.

Operation 1530: Score points.

For example, a plurality of points (candidate positions) are obtained after the point marking, and the client provides a preset configuration, such as an assigned value of a distance from the master virtual object (a first distance score), an assigned value of a virtual barrier (an obstacle score), an assigned value of an enemy unit (for example, a second distance score), and an assigned value of an ally unit. Each small square region is determined and scored, to obtain position evaluation scores respectively corresponding to the plurality of candidate positions.

Operation 1540: Determine whether the player enables precise summoning.

For example, the precise summoning is configured for representing whether to enable the first summoning function to display a highlight region. Enabling the first summoning function represents that the character summoning range configured for summoning the first virtual minion character may be selected within the current field of view.

In some embodiments, if the player enables the precise summoning (Yes), operation 1551 to operation 1554 below are performed; or if the player does not enable the precise summoning (No), operation 1561 to operation 1563 below are performed.

Operation 1551: Display a highlight region that can be dragged by the player.

For example, if the player enables the precise summoning, for example, a first summoning function is enabled in a setting control, a light-emitting region is displayed as the highlight region within the current field of view, for example, a light-emitting region is generated at a mouse position of the player. When the player moves the mouse or performs another dragging operation, the highlight region is caused to move in a direction of the dragging, and the highlight region always moves along the virtual ground.

Operation 1552: Assign an additional score to the highlight region.

For example, the additional score starts to be assigned when the position of the highlight region remains unchanged for a period. For example, the additional score starts to be assigned when the position of the highlight region remains unchanged for 2 seconds. The client additionally adds a score to the highlight region, for example, evaluates a gain effect of summoning the first virtual minion character at different positions in the highlight region, to obtain a position evaluation score.

Operation 1553: The player releases the summoning button to start summoning.

For example, when the player releases the summoning button, the client sends a summoning protocol to the server, to request to summon the first virtual minion character.

Operation 1554: Generate a first virtual minion character at a point with a highest score in the highlight region.

For example, after the server returns the summoning protocol, the client generates a summoned object (the first virtual minion character) at the point with the highest score within the highlight region, that is, displays the summoned object at the first position.

Operation 1561: Display a virtual light beam at a point with a highest score.

For example, if the player does not enable the precise summoning, the point with the highest score within the current field of view is evaluated. For example, a candidate position corresponding to a highest position evaluation score is determined, the point is used as the first position, and the virtual light beam is displayed at the first position.

In some embodiments, a display position of the virtual light beam is dynamically adjusted based on a change of an objective condition (such as a viewing angle of a camera of the player and a position of an enemy virtual object), so that it is ensured that the virtual light beam is always displayed at the position with the highest score, that is, an optimal summoning point.

Operation 1562: The player releases the summoning button to start summoning.

For example, when the player releases the summoning button, the client sends a summoning protocol to the server, to request to summon the first virtual minion character.

Operation 1563: Generate a first virtual minion character at a position of the virtual light beam.

For example, after the server returns the summoning protocol, the client generates the summoned object (the first virtual minion character) at the first position at which the virtual light beam is displayed.

The foregoing descriptions are merely exemplary examples, and are not limited in this embodiment of this application.

In this embodiment of this application, time and energy required by the player to summon a virtual minion character are reduced. After statistics collection, when the precise summoning (the first summoning function) is enabled, a summoning process of the player is shortened by more than 50%; and when the precise summoning option is disabled, a summoning process of the player is shortened by more than 90%. When summoning the virtual minion character, the player can quickly summon the virtual minion character without excessive energy. In a summoning process, an occurrence rate of non-ideal points caused by blocking of a virtual terrain is reduced, and the virtual minion character can quickly enter a process such as virtual combat and resource mining. Smoothness of summoning of the player and satisfaction of the player experience are improved, and a good result is achieved.

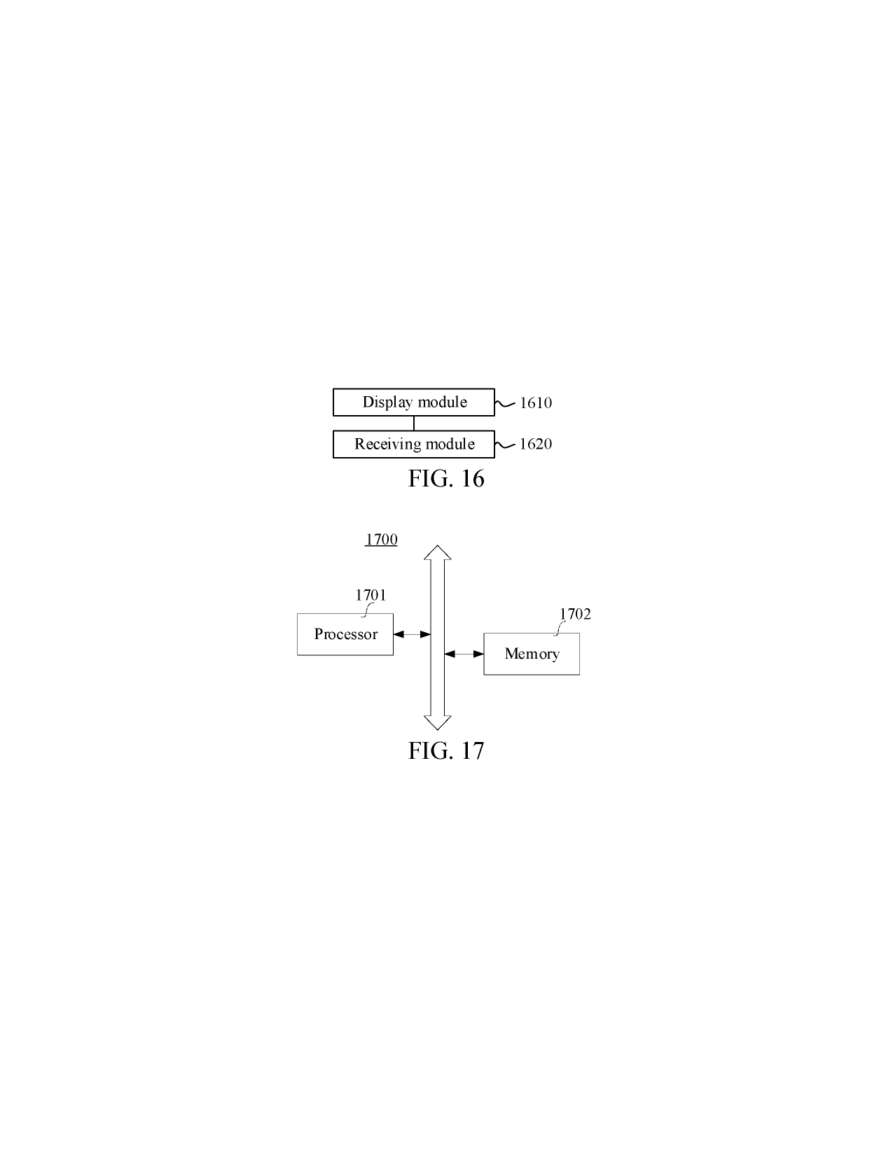

FIG. 16 is a structural block diagram of an apparatus for summoning a virtual minion character according to an exemplary embodiment of this application. As shown in FIG. 16, the apparatus includes the following parts:

a display module 1610, configured to display a master virtual object in a virtual scene, the master virtual object having a capability of summoning a virtual minion character, and the virtual minion character including a pet character captured by the master virtual object in the virtual scene; and

a receiving module 1620, configured to receive a character summoning operation, the character summoning operation being configured for summoning a first virtual minion character, and the first virtual minion character being a virtual minion character selected as a servant of the master virtual object,

the display module 1610 being further configured to display the summoned first virtual minion character at a first position within a current field of view in response to the character summoning operation, the first position being dynamically determined based on an element position of at least one specified element within the current field of view, and the specified element being a virtual element affecting a character summoning result of the first virtual minion character within the current field of view.

In an exemplary embodiment, the receiving module 1620 is further configured to obtain, in response to the character summoning operation, summoning matching data respectively corresponding to a plurality of candidate positions within the current field of view, the summoning matching data being data determined based on a positional relationship between the candidate positions and the at least one specified element; and determine the candidate position corresponding to the summoning matching data meeting a first matching requirement as the first position, and display the first virtual minion character at the first position.

In an exemplary embodiment, the receiving module 1620 is further configured to evaluate, based on a positional relative relationship between the candidate positions and the at least one specified element in response to the character summoning operation, a gain effect of summoning the first virtual minion character at the candidate positions, to obtain position evaluation scores respectively corresponding to the plurality of candidate positions as the summoning matching data, the gain effect being an effect of assisting the master virtual object by using the first virtual minion character, and strength of the gain effect being directly proportional to a value of the position evaluation score.

In an exemplary embodiment, for a first candidate position in the plurality of candidate positions, obtaining the position evaluation score includes at least one of the following:

obtaining a first distance score based on a first distance between the first candidate position and the master virtual object, the first distance being inversely proportional to the first distance score, and the at least one specified element including the master virtual object;

obtaining a second distance score based on a second distance between the first candidate position and another virtual object, the second distance being inversely proportional to the second distance score, and the at least one specified element including the another virtual object other than the master virtual object in the virtual scene;

obtaining a third distance score based on a third distance between the first candidate position and another virtual minion character, the third distance being inversely proportional to the third distance score, and the at least one specified element including the another virtual minion character other than the first virtual minion character in the virtual scene;

obtaining an obstacle score based on a hindering effect of a virtual obstacle at the first candidate position on summoning the first virtual minion character, the hindering effect being inversely proportional to the obstacle score, and the at least one specified element including the virtual obstacle;

obtaining a terrain score based on an influence degree of a virtual terrain at the first candidate position on summoning the first virtual minion character, the influence degree being inversely proportional to the terrain score, and the at least one specified element including the virtual terrain;

obtaining a resource mining score based on a mining difficulty of mining a virtual resource by the first virtual minion character at the first candidate position, the mining difficulty being inversely proportional to the resource mining score, and the at least one specified element including the virtual resource; or

obtaining a place score based on a matching degree between the first virtual minion character and a virtual place at the first candidate position, the matching degree being directly proportional to the place score, and the at least one specified element including the virtual place.

In an exemplary embodiment, the receiving module 1620 is further configured to determine the candidate position corresponding to a highest position evaluation score as the first position; or determine the candidate position whose position evaluation score exceeds a first score threshold as the first position.

In an exemplary embodiment, the display module 1610 is configured to display a summoning indicator element at the first position within the current field of view in response to the character summoning operation, the summoning indicator element being configured for prompting summoning a virtual minion character; and display the first virtual minion character at the first position at which the summoning indicator element is displayed.

In an exemplary embodiment, the display module 1610 is configured to display a virtual light beam as the summoning indicator element at the first position within the current field of view in response to the character summoning operation; or display a virtual curtain as the summoning indicator element at the first position within the current field of view in response to the character summoning operation.

In an exemplary embodiment, the display module 1610 is configured to display a highlight region within the current field of view in response to the character summoning operation, the highlight region being configured for representing a character summoning range of the first virtual minion character; and display the summoned first virtual minion character at a first position in the highlight region, the first position being a position determined based on a positional relative relationship between at least one candidate position in the highlight region and the at least one specified element.

In an exemplary embodiment, the display module 1610 is configured to display the highlight region within the current field of view in response to receiving a position selection operation when the character summoning operation is received, the position selection operation being configured for selecting, within the current field of view, a region display position of the highlight region.

In an exemplary embodiment, the display module 1610 is configured to display, in response to receiving the position selection operation pointing to a first display position within the current field of view, a preset circular region with the first display position as a circle center as the highlight region.

In an exemplary embodiment, the display module 1610 is configured to display the highlight region within the current field of view in response to the character summoning operation when a first summoning function is enabled, the first summoning function being a function of selecting, within the current field of view, a character summoning range configured for summoning the first virtual minion character.

In an exemplary embodiment, the display module 1610 is configured to determine the at least one candidate position located in the highlight region; evaluate, based on the positional relative relationship between the at least one candidate position and the at least one specified element, a gain effect of summoning the first virtual minion character at the at least one candidate position, to obtain summoning matching data respectively corresponding to the at least one candidate position; and determine the first position based on the summoning matching data, and display the summoned first virtual minion character at the first position.

In an exemplary embodiment, the receiving module 1620 is configured to receive a pet selection operation, the pet selection operation being configured for selecting the first virtual minion character from at least one virtual minion character possessed by the master virtual object, the at least one virtual minion character being a virtual minion character captured from the virtual scene based on a pet capture operation.

In an exemplary embodiment, the receiving module 1620 is configured to display at least one character identifier when the character summoning operation is received, the at least one character identifier being in a one-to-one correspondence with the at least one virtual minion character; and receive a selection operation for a first character identifier in the at least one character identifier as the pet selection operation, the first character identifier being a character identifier corresponding to the first virtual minion character.

In an exemplary embodiment, the receiving module 1620 is configured to select a plurality of candidate positions from the current field of view based on a position selection rule in response to the character summoning operation, the position selection rule being configured for representing density of the selected plurality of candidate positions; and the position selection rule including at least one of a first selection rule configured by default or a second selection rule determined based on a rule configuration operation.

In an exemplary embodiment, the receiving module 1620 is configured to determine a sectoral region as the current field of view based on an orientation and a position of the master virtual object in response to the character summoning operation; and divide the sectoral region based on a grid size determined according to the position selection rule, to obtain a plurality of grid regions as the plurality of candidate positions.

In an exemplary embodiment, the receiving module 1620 is configured to display a plurality of configuration options in response to receiving the rule configuration operation, the configuration option being configured for adjusting position sparsity when the candidate positions are selected based on the character summoning operation; and the position sparsity being directly proportional to a quantity of the candidate positions; and determine, in response to receiving a selection operation for a first configuration option in the plurality of configuration options, a first degree of sparsity corresponding to the first configuration option as the second selection rule.

In an exemplary embodiment, the receiving module 1620 is configured to determine the first position within the current field of view in response to the character summoning operation; select, based on matching degrees between the first position and a plurality of virtual minion characters, the first virtual minion character from the plurality of virtual minion characters, the plurality of virtual minion characters being virtual minion characters within a capability summoning range of the summoning capability; and display the summoned first virtual minion character at the first position.

In an exemplary embodiment, the receiving module 1620 is configured to match the first position with the plurality of virtual minion characters based on character attributes respectively corresponding to the plurality of virtual minion characters and a position parameter of the first position, to obtain the matching degrees respectively corresponding to the plurality of virtual minion characters, the character attribute including at least one of an assistance attribute, a counter attribute, or a gathering attribute of the virtual minion character, and the position parameter including at least one of a position parameter, an obstacle parameter, a terrain parameter, a resource parameter, or an additional assignment parameter between a candidate position and a virtual object; and determine at least one virtual minion character whose matching degree meets a second matching requirement as the first virtual minion character.

In an exemplary embodiment, the receiving module 1620 is configured to display, in response to the character summoning operation when a second virtual minion character exists within the current field of view, a movement animation in which the second virtual minion character moves to the first position, the second virtual minion character including at least one of the following virtual minion characters: the second virtual minion character and the master virtual object being both in a first virtual camp; or the master virtual object being in a first virtual camp, the second virtual minion character being in a second virtual camp, and a first team level of the first virtual camp being higher than a second team level of the second virtual camp.

In conclusion, at least one specified element within a field of view affecting the character summoning result of the first virtual minion character is used as a factor during summoning of a virtual minion character, so that a more suitable first position for summoning the first virtual minion character is dynamically selected by using the element position of the at least one specified element in the virtual scene. This improves efficiency of selecting the first position, avoids relying on manual operation of the player to determine the summoning position of the virtual minion character, improves the display flexibility of the virtual minion character, lowers an operational threshold for summoning the virtual minion character, and improves the efficiency of human-computer interaction.

The apparatus for summoning a virtual minion character provided in the foregoing embodiments is illustrated with an example of division of the foregoing functional modules. In actual application, the functions may be allocated to and completed by different functional modules according to requirements, that is, the internal structure of the device is divided into different functional modules, to implement all or some of the functions described above. In addition, the apparatus for summoning a virtual minion character provided in the foregoing embodiment belongs to the same idea as the embodiment of the method for summoning a virtual minion character. For a specific implementation process thereof, refer to the method embodiment. Details are not described herein again.

FIG. 17 is a structural block diagram of an electronic device 1700 according to an exemplary embodiment of this application. The electronic device 1700 may be a portable mobile terminal, such as a smartphone, an in-vehicle terminal, a tablet computer, a moving picture experts group audio layer III (MP3) player, a moving picture experts group audio layer IV (MP4) player, a notebook computer, or a desktop computer. The electronic device 1700 may also be referred to as another name such as user equipment, a portable terminal, a laptop terminal, or a desktop terminal. The electronic device 1700 includes a processor 1701 and a memory 1702. The processor 1701 may include one or more processing cores, such as a 4-core processor and an 8-core processor. The memory 1702 may include one or more computer-readable storage media. The computer-readable storage medium may be non-transient.

In some embodiments, the electronic device 1700 further includes one or more sensors. The one or more sensors include, but are not limited to, a proximity sensor, a gyroscope sensor, and a pressure sensor. The proximity sensor, also referred to as a distance sensor, is usually disposed on a front panel of the electronic device 1700. The gyroscope sensor can detect a body direction and a rotation angle of the electronic device 1700. The gyroscope sensor may cooperate with an acceleration sensor to collect a 3D action by a user on the electronic device 1700. The pressure sensor may be disposed on a side frame of the electronic device 1700 and/or a lower layer of the display screen.

In some embodiments, the electronic device 1700 further includes other component parts. A person skilled in the art may understand that the structure shown in FIG. 17 constitutes no limitation on the electronic device 1700, and the electronic device may include more or fewer components than those shown in the figure, or some components may be combined, or a different component deployment may be used.

What is claimed is:

1. A method for summoning a virtual minion character performed by a computer device, the method comprising:
displaying a graphical user interface of a virtual scene including a master virtual object, the master virtual object having a capability of summoning a virtual minion character captured by the master virtual object in the virtual scene;
receiving a character summoning operation for summoning a first virtual minion character in the virtual scene;
in response to the character summoning operation, determining, within a current field of view of the master virtual object, summoning matching data respectively corresponding to a plurality of candidate positions based on a positional relationship between the candidate positions and an element position of at least one specified element within the current field of view;
determining, among the plurality of candidate positions, a candidate position whose corresponding summoning matching data meets a first matching requirement as a first position within the current field of view; and
displaying the summoned first virtual minion character at the first position within the current field of view.

2. The method according to claim 1, wherein the determining, within the current field of view of the master virtual object, summoning matching data respectively corresponding to a plurality of candidate positions based on a positional relationship between the candidate positions and an element position of at least one specified element within the current field of view comprises:
evaluating a gain effect of summoning the first virtual minion character at the candidate positions based on the positional relative relationship between the candidate positions and the at least one specified element, to obtain position evaluation scores respectively corresponding to the plurality of candidate positions as the summoning matching data.

3. The method according to claim 2, wherein the gain effect is proportional to strength of the first virtual minion character assisting the master virtual object in attacking another virtual object in the virtual scene.

4. The method according to claim 2, wherein a position evaluation score for a first candidate position in the plurality of candidate positions is determined by performing at least one of the following:
obtaining a first distance score based on a first distance between the first candidate position and the master virtual object;
obtaining a second distance score based on a second distance between the first candidate position and another virtual object;
obtaining a third distance score based on a third distance between the first candidate position and another virtual minion character;
obtaining an obstacle score based on a hindering effect of a virtual obstacle at the first candidate position on summoning the first virtual minion character;
obtaining a terrain score based on an influence degree of a virtual terrain at the first candidate position on summoning the first virtual minion character;
obtaining a resource mining score based on a mining difficulty of mining a virtual resource by the first virtual minion character at the first candidate position; and/or
obtaining a place score based on a matching degree between the first virtual minion character and a virtual place at the first candidate position.

5. The method according to claim 1, wherein the determining, among the plurality of candidate positions, the candidate position whose corresponding summoning matching data meets the first matching requirement as the first position within the current field of view comprises:
determining, among the plurality of candidate positions, a candidate position corresponding to a highest position evaluation score as the first position; or
determining, among the plurality of candidate positions, a candidate position whose position evaluation score exceeds a first score threshold as the first position.

6. The method according to claim 1, wherein the displaying the summoned first virtual minion character at the first position within the current field of view comprises:
displaying a summoning indicator element at the first position within the current field of view for prompting summoning a virtual minion character; and
displaying the first virtual minion character at the first position near the summoning indicator element.

7. The method according to claim 6, wherein the displaying a summoning indicator element at the first position within the current field of view for prompting summoning a virtual minion character comprises:
displaying a virtual light beam as the summoning indicator element at the first position within the current field of view in response to the character summoning operation; or
displaying a virtual curtain as the summoning indicator element at the first position within the current field of view in response to the character summoning operation.

8. The method according to claim 1, wherein the displaying the summoned first virtual minion character at the first position within the current field of view comprises:
displaying a highlight region within the current field of view, the highlight region being configured for representing a character summoning range of the first virtual minion character; and
displaying the summoned first virtual minion character at a first position in the highlight region based on a positional relative relationship between at least one candidate position in the highlight region and the at least one specified element.

9. The method according to claim 8, wherein the displaying the highlight region within the current field of view comprises:
displaying the highlight region within the current field of view in response to receiving a position selection operation when the character summoning operation is received, the position selection operation being configured for selecting, within the current field of view, a region display position of the highlight region.

10. The method according to claim 8, wherein the displaying the summoned first virtual minion character at the first position in the highlight region comprises:
determining the at least one candidate position located in the highlight region;
evaluating a gain effect of summoning the first virtual minion character at the at least one candidate position based on the positional relative relationship between the at least one candidate position and the at least one specified element, to obtain summoning matching data respectively corresponding to the at least one candidate position; and
determining the first position based on the summoning matching data, and displaying the summoned first virtual minion character at the first position.

11. The method according to claim 1, further comprising:
in response to the character summoning operation, selecting the plurality of candidate positions from the current field of view based on a density of the selected plurality of candidate positions.

12. The method according to claim 1, wherein the displaying the summoned first virtual minion character at the first position within the current field of view comprises:
selecting the first virtual minion character from the plurality of virtual minion characters based on matching degrees between the first position and the plurality of virtual minion characters within a capability summoning range of the summoning capability; and
displaying the summoned first virtual minion character at the first position.

13. The method according to claim 12, wherein the selecting the first virtual minion character from the plurality of virtual minion characters based on matching degrees between the first position and the plurality of virtual minion characters within a capability summoning range of the summoning capability comprises:
matching the first position with the plurality of virtual minion characters based on character attributes respectively corresponding to the plurality of virtual minion characters and a position parameter of the first position, to obtain the matching degrees respectively corresponding to the plurality of virtual minion characters; and
determining at least one virtual minion character whose matching degree meets a second matching requirement as the first virtual minion character.

14. A computer device, comprising a processor and a memory, the memory having at least one program stored therein, and the at least one program, when executed by the processor, causing the computer device to implement a method for summoning a virtual minion character including:
displaying a graphical user interface of a virtual scene including a master virtual object, the master virtual object having a capability of summoning a virtual minion character captured by the master virtual object in the virtual scene;
receiving a character summoning operation for summoning a first virtual minion character in the virtual scene;
in response to the character summoning operation, determining, within a current field of view of the master virtual object, summoning matching data respectively corresponding to a plurality of candidate positions based on a positional relationship between the candidate positions and an element position of at least one specified element within the current field of view;
determining, among the plurality of candidate positions, a candidate position whose corresponding summoning matching data meets a first matching requirement as a first position within the current field of view; and
displaying the summoned first virtual minion character at the first position within the current field of view.

15. The computer device according to claim 14, wherein the determining, within the current field of view of the master virtual object, summoning matching data respectively corresponding to a plurality of candidate positions based on a positional relationship between the candidate positions and an element position of at least one specified element within the current field of view comprises:
evaluating a gain effect of summoning the first virtual minion character at the candidate positions based on the positional relative relationship between the candidate positions and the at least one specified element, to obtain position evaluation scores respectively corresponding to the plurality of candidate positions as the summoning matching data.

16. The computer device according to claim 14, wherein the determining, among the plurality of candidate positions, the candidate position whose corresponding summoning matching data meets the first matching requirement as the first position within the current field of view comprises:
determining, among the plurality of candidate positions, a candidate position corresponding to a highest position evaluation score as the first position; or
determining, among the plurality of candidate positions, a candidate position whose position evaluation score exceeds a first score threshold as the first position.

17. The computer device according to claim 14, wherein the displaying the summoned first virtual minion character at the first position within the current field of view comprises:
displaying a summoning indicator element at the first position within the current field of view for prompting summoning a virtual minion character; and
displaying the first virtual minion character at the first position near the summoning indicator element.

18. The computer device according to claim 14, wherein the method further comprises:
in response to the character summoning operation, selecting the plurality of candidate positions from the current field of view based on a density of the selected plurality of candidate positions.

19. The computer device according to claim 14, wherein the displaying the summoned first virtual minion character at the first position within the current field of view comprises:
selecting the first virtual minion character from the plurality of virtual minion characters based on matching degrees between the first position and the plurality of virtual minion characters within a capability summoning range of the summoning capability; and
displaying the summoned first virtual minion character at the first position.

20. A non-transitory computer-readable storage medium, having at least one program stored therein, the at least one program, when executed by a processor of a computer device, causing the computer device to implement a method for summoning a virtual minion character including:
displaying a graphical user interface of a virtual scene including a master virtual object, the master virtual object having a capability of summoning a virtual minion character captured by the master virtual object in the virtual scene;
receiving a character summoning operation for summoning a first virtual minion character in the virtual scene;
in response to the character summoning operation, determining, within a current field of view of the master virtual object, summoning matching data respectively corresponding to a plurality of candidate positions based on a positional relationship between the candidate positions and an element position of at least one specified element within the current field of view;
determining, among the plurality of candidate positions, a candidate position whose corresponding summoning matching data meets a first matching requirement as a first position within the current field of view; and
displaying the summoned first virtual minion character at the first position within the current field of view.
